(19) United States
(12) Patent Application Publication
(10) Pub. No.: US 2026/0278267 A1
(43) Pub. Date: Sep. 17, 2026

(54) Enhancing Language Model Responses Using Segmented Multi-Model Ensembling

(71) Applicant: Oracle International Corporation, Redwood Shores, CA (US)

(72) Inventors: Jyotika Singh, San Diego, CA (US); Fang Tu, Edmonds, WA (US); Sandip Ghoshal, Dublin, CA (US); Vijayalakshmi Krishnamurthy, Sunnyvale, CA (US)

(73) Assignee: Oracle International Corporation, Redwood Shores, CA (US)

(21) Appl. No.: 19/079,132

(22) Filed: Mar. 13, 2025

(51) Int. Cl. G06F 40/20; G06F 16/35; G06F 16/383

(52) U.S. Cl. CPC G06F 40/20; G06F 16/35; G06F 16/383

(57) ABSTRACT

Techniques for generating accurate responses to queries using multiple language models and source document validation are disclosed. The techniques include receiving a source document and a query that are then processed through multiple language models to generate various responses. These responses are analyzed to identify segments that are both relevant to the query and validated against the source document for accuracy. From these validated segments, a second subset is determined. The techniques then order these segments based on their relative positions within either the source document or the language model responses. A comprehensive response is generated using this ordered set of segments. This approach ensures that the final response is accurate, relevant, and maintains a logical flow based on the original document structure. The techniques combine multiple language mode outputs while maintaining source document fidelity through systematic validation and ordering.

### TECHNICAL FIELD

This disclosure relates generally to language model processing. More particularly, this disclosure relates to ensemble language model operations.

### BACKGROUND

Natural language processing (NLP) systems have become increasingly important for processing and analyzing large volumes of textual data. In particular, large language models (LLMs) have emerged as powerful tools for various tasks, such as text summarization, question answering, and information extraction. These models can process source documents and generate natural language responses to user queries about the content of those documents.

However, existing approaches face several challenges. Individual language models often have varying strengths and weaknesses when processing different types of content or addressing different aspects of a query. While one model may excel at extracting certain types of information, it may miss or incorrectly represent other important details. This can lead to incomplete or inaccurate responses that fail to fully address the user's information needs.

Additionally, implementing sophisticated language model capabilities often requires significant computational resources. Approaches that rely on large, fine-tuned models typically incur substantial infrastructure and computing costs. The need for extensive training data and model fine-tuning also increases development complexity and makes it difficult to adapt systems for new use cases or domains.

Furthermore, ensuring the factual accuracy and relevance of generated responses remains an ongoing challenge. Language models may sometimes generate content that is not properly grounded in the source material or that includes information that, while plausible, is not actually supported by the input documents. Traditional approaches that process responses as complete units rather than examine individual components of the response make it difficult to identify and address such issues while preserving valuable content.

There remains a need for improved approaches that can leverage the capabilities of language models while addressing these technical challenges in a practical and cost-effective manner.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for processing document queries using multiple language models to generate responses based on validated and ordered segments according to one or more embodiments;

FIG. 2 illustrates a system for removing duplicate segments from a first subset of segments to determine a second subset of segments for response generation according to one or more embodiments;

FIG. 3 illustrates a system for generating multiple types of scores from language model responses and identifying segments based on comparisons with a source document according to one or more embodiments;

FIG. 4 illustrates a system for segmenting source documents, queries, and language model responses using distinct segmentation strategies based on document structure, topics, and sentence boundaries according to one or more embodiments;

FIG. 5 illustrates a system for combining segment orderings derived from language model responses, source document positions, and query topics to generate ordered text segments according to one or more embodiments;

FIG. 6 illustrates a system for enhancing a query with related terms, extracting topics, and identifying relevant segments based on the enhanced query according to one or more embodiments;

FIG. 7 illustrates a system for evaluating extracted claims from language model responses against semantic chunks to determine consistency scores and identify valid segments according to one or more embodiments;

FIG. 8 illustrates a system for parallel processing of source documents using multiple language models and performing simultaneous validity and relevance evaluations according to one or more embodiments;

FIG. 9 illustrates a system for generating an ordered subset of segments by combining weighted position-based signals from source documents and language model responses according to one or more embodiments;

FIG. 10 illustrates a system for processing language model responses through topic modeling, categorizing segments according to extracted topics, and identifying relevant query-aligned content according to one or more embodiments;

FIG. 11 illustrates an example transformer model architecture that may be used in the implementation of a language model according to one or embodiments; and

FIG. 12 is a block diagram that illustrates an example computer system upon which one or more embodiments are implemented.

### DETAILED DESCRIPTION

In the following detailed description, for the purposes of explanation, numerous specific details are set forth to aid understanding of one or more embodiments of the present disclosure. In some instances, one or embodiments of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In one or more embodiments, well-known structures and devices are shown in the figures in block diagram form to avoid unnecessarily obscuring the embodiment.
1. GENERAL OVERVIEW
2. ENHANCING LANGUAGE MODEL RESPONSES USING SEGMENTED MULTI-MODEL ENSEMBLING
   2.1. DUPLICATE SEGMENT REMOVAL
   2.2. SCORE GENERATION AND SEGMENT IDENTIFICATION
   2.3. INPUT-SPECIFIC SEGMENTATION
   2.4. RESPONSE ORDERING
   2.5. ENHANCED QUERY PROCESSING
   2.6. CLAIM EVALUATION
   2.7. PARALLEL PROCESSING
   2.8. WEIGHTED ORDERING
   2.9. LANGUAGE MODEL RESPONSE PROCESSING
3. EXAMPLE EMBODIMENT
4. PRACTICAL APPLICATIONS; ADVANTAGES; IMPROVEMENTS
5. EXAMPLE LANGUAGE MODEL ARCHITECTURE
6. COMPUTER NETWORKS AND CLOUD NETWORKS
7. HARDWARE OVERVIEW
8. MISCELLANEOUS; EXTENSIONS

### 1. GENERAL OVERVIEW

One or more embodiments process source documents and user queries through multiple language models in parallel to generate improved responses. By leveraging multiple language models simultaneously, one or more embodiments take advantage of different models'respective strengths while mitigating their individual weaknesses.

One or more embodiments process responses from multiple language models through a multi-stage processing pipeline. During initial processing stages, segments of the language model responses are evaluated for both their relevance to the user query and their validity with respect to the source document. This evaluation helps identify response segments that are both pertinent to the user's information needs and properly grounded in the source material.

After identifying valid and relevant segments from the various language model responses, one or more embodiments further refine and organize the segments. The relative positioning of segments is analyzed with respect to both the original source document and the language model responses to determine an optimal ordering that maintains logical flow and coherence.

One or more embodiments generate the final response by combining the processed segments in their determined order. This approach enables the creation of comprehensive responses that incorporate the strongest elements from multiple language model outputs while maintaining factual accuracy and relevance to the query.

One or more embodiments operate in an unsupervised manner without requiring model fine-tuning or extensive training data. This allows for flexible deployment across different domains and use cases while maintaining cost-effectiveness. The parallel processing of multiple smaller language models can provide capabilities comparable to larger, more expensive models at a fraction of the computational cost.

The segment-level processing approach enables more granular analysis and control over response generation compared to techniques that operate on complete responses. This granularity allows for more precise identification and handling of both strengths and weaknesses in the language model outputs.

One or more embodiments described in this Specification and/or recited in the claims may not be included in the General Overview section.

### 2.0 ENHANCING LANGUAGE MODEL RESPONSES USING SEGMENTED MULTI-MODEL ENSEMBLING

One or more embodiments will now be described with respect to the figures. In one or more embodiments, a system depicted in a figure may include more or fewer components than the components illustrated in the figure. The components illustrated in the figure may be local to or remote from each other. The components illustrated in the figure may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in Section 6, titled “Computer Networks and Cloud Networks.” In one or more embodiments, one or more operations of method illustrated in a figure may be modified, rearranged, or omitted. Accordingly, the particular sequence of operations illustrated in a figure should not be construed as limiting the scope of one or more embodiments.

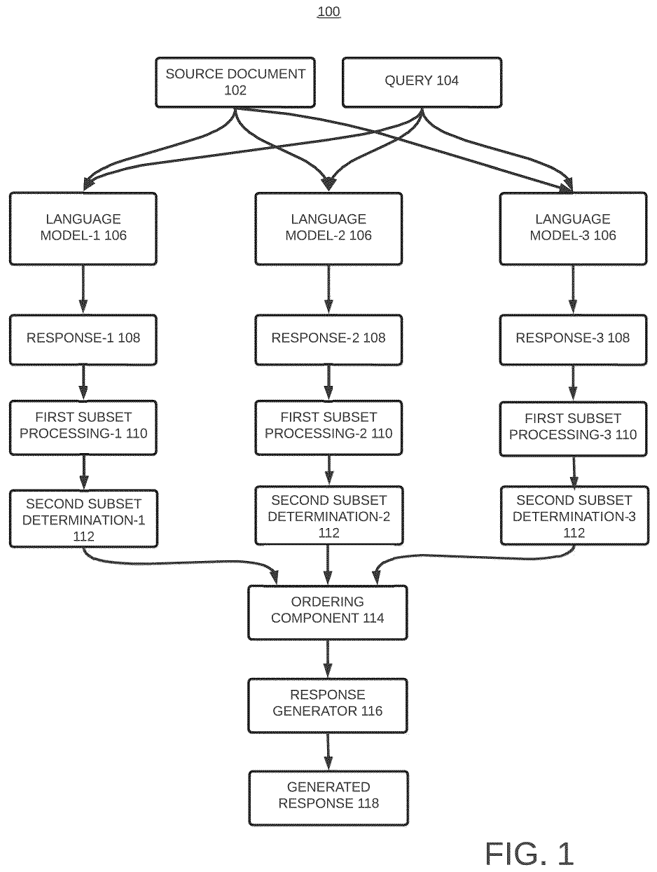

FIG. 1 illustrates a system 100 for processing document queries using multiple language models to generate responses based on validated and ordered segments, according to one or more embodiments.

The system 100 processes documents and queries using multiple language models to generate validated responses. The system 100 begins by receiving both a source document and a query as inputs. The system then processes these inputs using multiple language models to obtain a plurality of language model responses.

The system 100 analyzes the language model responses to identify a first subset of segments that meet two criteria. One, the segments are required to be relevant to the input query. Two, the segments are required to be validated by comparing them against the source document to ensure their validity.

From this first subset of segments, the system and method 100 determines a second subset of segments. The system 100 then orders these segments by analyzing their relative positions within either the source document, the language model responses, or both. This ordering process yields an ordered second subset of segments.

Finally, the system and method 100 generates a response based on the ordered second subset of segments. This systematic approach ensures that the generated response is both relevant to the query and grounded in the source document while maintaining appropriate contextual ordering of the information.

The source document input 102 represents the initial document that serves as ground truth for the processing pipeline. This input can include a single document or multiple documents that include the source material for processing. The source document input 102 is received along with a query to initiate the language model processing workflow.

For example, the source document input 102 could be a construction-based document of substantial length such as a 20-page request for proposal (RFP) document. The system processes this input by breaking the document down into segments for comparison against language model responses. The segmentation approach varies based on the document's structure—structured documents are split by sections first, while unstructured documents undergo chunking with different appropriate window sizes. For these unstructured documents, the system applies topic modeling to determine meaningful segments and dynamically adjusts the chunk sizes based on the strength of identified topic clusters.

The source document input 102 serves multiple functions in the processing pipeline. The input acts as the reference point for validating language model outputs through similarity comparisons, content coverage scoring, and factual consistency checks. The system compares language model response segments against segments from the source document input 102 to identify the content that is properly grounded versus potentially hallucinated information that should be removed.

When processing the source document input 102, the system employs handling based on document type and structure. For structured documents, the system first splits by sections, identifies sections relevant to the query, and performs sub-segmentation as needed. For unstructured documents, the system uses chunking with different appropriate window sizes, applies topic modeling for segmentation, and adjusts chunk sizes based on cluster strength.

The query input 104 represents an initial component of the method where both a source document and a query are received as inputs to the system. The query input can take various forms, such as requests for summarization, synthesis, rewriting, or other NLP tasks. The query part of the input serves to guide the system in extracting relevant information from the source document. For example, when processing construction-based documents, the query might specifically request information about demolition components or pre-construction components within a larger document.

The query input works in conjunction with the source document to establish the foundation for subsequent processing steps. The source document serves as the ground truth against which language model outputs will be validated. For instance, if processing a 20-page construction document, the query input might ask for a summary of specific sections, while the source document provides the factual basis for verifying the accuracy of language model responses.

The system is designed to handle queries of varying complexity, from simple summarization requests to more complex analytical questions. When queries are short or minimal, the system includes functionality to augment them with related keywords and phrases using pre-trained language models, expanding the query to provide more robust comparison targets for later processing stages. This augmentation helps improve the system's ability to identify relevant content in the language model responses while maintaining fidelity to the original query intent.

The language models 106 refer to multiple artificial intelligence models capable of processing and generating natural language text. These models work together in an ensemble approach to process source documents and queries. The language models 106 represent foundational, weak, small, and/or low-cost language models that can be combined to create stronger, more cohesive responses. For example, different language model versions may be used. A language model in the ensemble may have different strengths in detecting and extracting various pieces of information while potentially missing others. The models process inputs in parallel to optimize performance with each model generating a unique response to the source document and query. The parallel processing approach allows the system to leverage multiple smaller, more cost-effective models instead of relying on a single large, expensive model. This implementation provides a practical solution that maintains high-quality results while significantly reducing computational costs, such as, for example, a potential GPU cost savings of up to 40 times compared to using a single, large, fine-tuned model.

The language model responses 108 represent multiple outputs generated by different language models when processing a source document and query. These responses serve as intermediate results that are further processed to create an enhanced final response. For example, when processing a 20-page construction document with a query about demolition components, different language models would each generate their own response, forming the set of language model responses 108. A language model may identify and extract different pieces of relevant information from the source document with some models potentially excelling at certain aspects while missing others.

The language model responses 108 are designed to be processed in parallel, where possible, to optimize performance. These responses may include varying types of content, including highly relevant information that should be included in the final output, somewhat relevant content that may be optional, and potentially incorrect or hallucinated content that needs to be filtered out. For instance, given a source document including points a, b, 1, 2, c, d, 3, e, one language model might generate a response “b, 3, X, 1” while another generates “Y, 1, 2, c, d, e”, with X and Y representing potential hallucinations that would need to be removed in subsequent processing steps.

The language model responses 108 form the foundation for the system's ensemble approach, where multiple smaller, more cost-effective models work together to produce results comparable to larger, more complex language models. This parallel processing of multiple language model responses enables the system to leverage the diverse strengths of different models while minimizing their individual weaknesses, ultimately leading to a more comprehensive and accurate final response.

The first subset processing component 110 represents an element of the system that handles the processing of language model responses to identify valid and relevant segments. The processing component performs filtering and validation operations on segments from multiple language model outputs. For example, when processing construction document summaries, processing component 110 would analyze responses from different language models to identify segments that accurately describe specific topics, such as demolition or pre-construction components. The processing component employs multiple methods to validate segments, including embedding similarity comparisons between source document and response segments. The component also calculates content coverage scores by analyzing the ratio of common terms between responses and the source document. Processing component 110 evaluates factual consistency using a cross-encoder model trained on natural language inference data. The component processes segments independently rather than in pairs, making the process computationally efficient. For example, when analyzing a 20-page construction document, processing component 110 would break down both the document and language model responses into segments, compute similarity scores between them, and filter out segments that fall below defined thresholds for factual consistency or relevance. This systematic processing approach ensures that segments that are factually accurate and relevant to the query are retained for the final response.

The second subset determination component 112 represents a system component that processes and refines segments from language model responses to create a more focused and relevant set of content. This component operates after initial filtering has identified segments that are query-relevant and valid based on source document comparison. In example implementation, the second subset determination component 112 processes filtered responses from multiple language models, such as converting a response with segments “3, 1” from language model1 and a response with segments “1, 2” from language model2 into a refined subset of segments.

The second subset determination component 112 employs multiple techniques to determine the segments that should be included in the final subset. For instance, the component performs deduplication to remove redundant segments that may appear across different language model responses. The component also leverages embedding-based similarity comparisons to identify and combine segments that express similar information in different ways.

The second subset determination component 112 specifically focuses on strength preservation in the final output. The component accomplishes this by comparing embedding representations of summary segments against each other, enabling cross-corroboration while eliminating redundancy. This process ensures that the strongest, most relevant segments are retained while maintaining efficiency by reducing the volume of text that needs to be processed in subsequent steps.

The component's operation is useful in the context of ensemble language model processing, as the component helps combine the unique strengths of different language models while avoiding duplication. For example, when processing construction document summaries, the component might identify and retain unique segments about demolition components from one language model while preserving pre-construction information from another, creating a more comprehensive final subset of segments.

The ordering component 114 is responsible for determining the optimal sequence of response segments in the final combined output. This component analyzes the relative positions of segments within both the source document and the individual language model responses to establish a logical and coherent ordering. For example, if one language model response includes segments “3, 1” and another includes “1, 2”, the ordering component 114 would analyze these sequences along with the source document structure to determine the proper ordering (e.g., “1, 2, 3”). The ordering component 114 employs multiple ordering signals through a three-step process that includes comparing segment similarity and ordering against individual language model responses, comparing against source document segment ordering, and comparing against user question topic ordering. These signals are combined in an ensemble fashion to produce the final segment sequence. The component uses cosine similarity between segment embeddings to determine relative positioning, matching segments from the ensemble response to segments in the reference texts based on the highest similarity scores. For instance, when processing construction-based documents, the ordering component 114 would ensure that pre-construction components are presented before demolition components if that matches the logical flow found in the source document. This systematic approach to ordering ensures that the final response maintains a natural and coherent progression of information, making the response appear as if the response came from a single, well-organized source rather than multiple combined outputs.

The response generator 116 is a component that creates an enhanced output by combining and processing responses from multiple language models. This component processes the source document and query through parallel language models and then refines their outputs through multiple stages. The response generator 116 implements a pipeline that includes weakness limitation, strength collation, and response corroboration to produce a cohesive final response.

For example, when processing a construction document query about demolition components, the response generator 116 would obtain responses from multiple language models. The response generator then analyzes these responses at a segment level to identify and retain factually correct and query-relevant content while filtering out hallucinations or irrelevant information. The response generator 116 employs various scoring mechanisms, including embedding similarity, content coverage scores, and factual consistency scores, to validate segments against the source document.

The response generator 116 determines the optimal ordering of valid segments by analyzing the segments'positions in both the source document and original language model responses. This helps ensure the final response maintains a logical flow. For instance, if one language model outputs segments in order “3, 1” and another outputs “1 ,2”, the response generator 116 would analyze these patterns along with the source document structure to determine the correct ordering “1, 2, 3” for the final response.

Through this processing pipeline, the response generator 116 creates a unified response that appears as if the response came from a single, high-quality language model, while actually leveraging the combined strengths of multiple, smaller, more cost-effective models. This approach provides significant advantages in terms of both performance and cost efficiency compared to using a single large language model.

The final generated response output 118 represents the culmination of the multi-stage language model ensemble processing pipeline that combines and refines outputs from multiple language models. This output is generated based on an ordered second subset of segments that have been validated against the source document and determined to be relevant to the user's query. The final generated response output 118 appears as a cohesive, single response that masks the complexity of the underlying, multi-language model processing.

Drawing from the disclosure, the final generated response output 118 is produced through several processing steps. For example, if two language models generate responses where language model1 outputs a response with segments “b, 3, X, 1” and language model2 outputs a response with segments “Y, 1, 2, c, d, e”, the system processes these through weakness limitation and strength collation to retain valid segments. These segments are then properly ordered (e.g., converting “3, 1, 2” to “1, 2, 3”) to create a logical final response.

The final generated response output 118 combines the strengths of multiple language models while minimizing their individual weaknesses. The system preserves language model strengths in this output by comparing embedding representations of summary segments against each other. This enables cross-corroboration while eliminating redundancy. The output appears as if the response came from a single language model despite being generated through an ensemble approach that leverages multiple, smaller, more cost-effective models working in parallel.

### 2.1 Duplicate Segment Removal

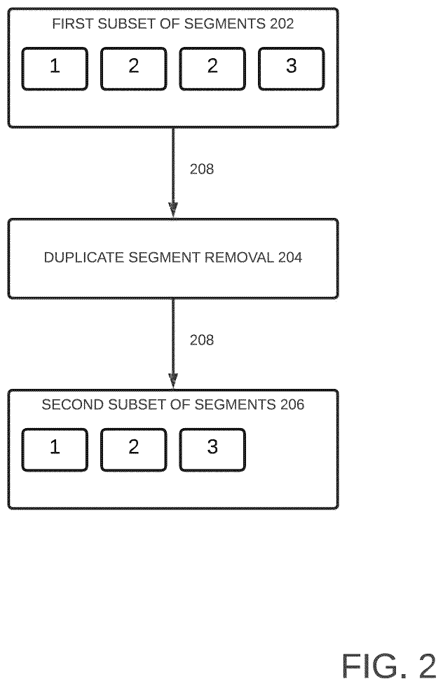

FIG. 2 illustrates a system 200 for removing duplicate segments from a first subset of segments to determine a second subset of segments for response generation according to one or more embodiments. The system 200 extends the system and method 100 of FIG. 1. Unless the context clearly indicates otherwise, the system and method 200 can be used in conjunction with or independent of other extensions of the system and method 100 of FIG. 1 described herein with respect to the other figures.

The system 200 processes the first subset of segments to create a second subset of segments by removing duplicate segments from the first subset. After obtaining language model responses and identifying segments that are both relevant to the query and valid based on the source document, the system and method 200 analyzes the first subset of segments to identify and eliminate redundant content. The deduplication step ensures that each unique piece of information appears once in the second subset of segments. The system 200 then proceeds to order these non-redundant segments based on the segments' positions in either the source document or the language model responses before generating the final response. The deduplication step helps create a more concise and non-repetitive response by preventing the same information from appearing multiple times in the final output.

The first subset of segments 202 represents an intermediate stage in a language model processing pipeline that includes validated segments from multiple language model responses. These segments have been verified to be factually consistent with the source document and relevant to the user's query, having passed through weakness limiter and strength collator components. While the segments may feature duplicate or similar content from different language model responses, the segments maintain the original form and ordering before undergoing deduplication processing. The segments have passed various validation checks, including embedding similarity comparison, content coverage scoring, and factual consistency evaluation.

The duplicate segment removal 204 component processes segments from multiple language model responses to eliminate redundant content. The component works by comparing segment embeddings using cosine similarity to identify and remove duplicate or highly similar segments. For example, if two language models generate responses with overlapping segments, the component ensures each unique segment appears once in the final output. This approach creates a more concise and coherent response by preventing repetition of information, even when expressed differently across language model outputs.

The second subset of segments 206 represents a refined collection of text segments that results from removing duplicates from an initial subset. This process is useful for improving language model outcomes using ensemble techniques. The system removes duplicate information by comparing segment embeddings and calculating cosine similarity to identify semantically equivalent content even when worded differently. This deduplication occurs within the response corroborator component and helps create an efficient, intermediate representation including unique, valuable information from multiple language model responses before final ordering and response generation.

Directional arrows (208) show how duplicate segments are removed from multiple language model outputs. The data processing system compares segments using embedding-based similarity measures to identify and eliminate duplicates. The deduplication process occurs after segments are validated against source documents but before final ordering. The data processing system uses cosine similarity between segment embeddings to determine duplicate segments, ensuring that identical or very similar content from different language models is retained once in the final output.

### 2.2 Score Generation and Segment Identification

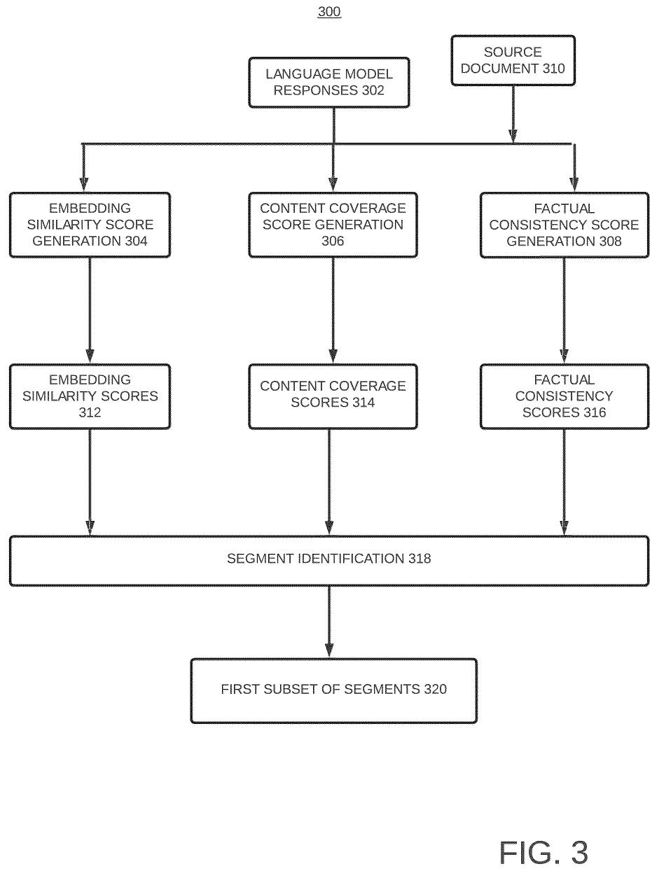

FIG. 3 illustrates a system 300 for generating multiple types of scores from language model responses and identifying segments based on comparisons with a source document according to one or more embodiments. The system 300 extends the system and method 100 of FIG. 1. Unless the context clearly indicates otherwise, the system and method 300 can be used in conjunction with or independent of other extensions of the system and method 100 of FIG. 1 described herein with respect to the other figures.

The system 300 processes language model responses to identify valid and relevant segments through multiple scoring approaches. The system generates embedding similarity scores by comparing vector representations of segments from the language model responses with vector representations of source document portions. The system also generates content coverage scores by analyzing how well content elements from the response segments align with content elements present in the source document. Additionally, the system generates factual consistency scores by evaluating specific claims made in the response segments against the information in the source document.

The system uses these generated scores—embedding similarity, content coverage, and factual consistency—to identify the first subset of segments that are relevant to the query and valid based on the source document. The system selects segments for inclusion in the first subset based on one or more of these scoring metrics meeting defined criteria. These identified segments then serve as input for determining the second subset of segments, which are subsequently ordered based on their positions in the source document or language model responses before being used to generate the final response.

This scoring and selection process ensures that the segments included in the response are semantically similar to the source content and maintain factual accuracy and appropriate coverage of the source material. The use of multiple scoring approaches provides a robust evaluation framework for validating the language model outputs against the source document.

Language model responses 302 are outputs from different types of language models processing a source document and query. These responses come from various models, including foundational, weak, small, and low-cost language models. A model may capture different aspects of information with some models detecting certain points while missing others.

The responses undergo quality evaluation through multiple scoring mechanisms, including embedding similarity scores, content coverage scores, and factual consistency scores, using a cross-encoder model. The system processes these responses in parallel to optimize performance, enabling the use of multiple smaller, cost-effective models instead of one large, expensive model. The responses then become the foundation for identifying and combining the strongest segments while removing hallucinations or irrelevant content.

Embedding similarity score generation 304 compares vector representations of language model response segments with source document segments to determine content alignment and validity. The process works by generating embedding similarity scores using cosine similarity measures, helping identify genuine content versus hallucinated content. The component operates within a “weakness limiter” subcomponent of the language model ensembler framework, processing segments independently for granular analysis. These similarity scores, combined with content coverage and factual consistency scores, help filter out inaccurate information and determine the segments that should be retained in the final response.

Content coverage score generation 306 evaluates how well language model responses align with source documents by comparing shared terms and content. The scoring system works by breaking down both the language model responses and source documents into detailed elements, like words, phrases, and entities, then calculating the ratio of matching terms. The system helps identify well-supported content versus potential hallucinations, working alongside other scoring mechanisms to validate responses. Operating within a larger weakness limitation process, the scoring mechanism filters out poorly supported segments using specific thresholds to ensure accuracy and relevance when combining multiple, language model responses.

Factual consistency score generation 308 checks the accuracy of claims made by language models against source documents. The system uses a cross-encoder model trained on natural language inference data to compare individual claims with relevant chunks of source documents. The system generates a matrix of scores for each claim-chunk comparison and determines final consistency scores by taking the maximum score across chunks. Claims scoring below a threshold are filtered out to prevent hallucinations and ensure factual accuracy in language model outputs.

Source document 310 serves as a reference document used to validate and evaluate language model responses through multiple comparison methods. The document can be various types of content, including construction, medical, and/or other domain-specific documents, and breaks down into segments for detailed comparison. The system uses three scoring methods to validate responses against Source Document 310: embedding similarity scores, content coverage scores, and factual consistency scores. These methods help filter and retain factually correct information from language model outputs by comparing them with the source material's content, structure, and claims.

Embedding similarity scores 312 represents a method for validating language model responses against source documents through vector-based comparison. The process encompasses segmenting both the model responses and source documents, converting these segments into vector embeddings and calculating similarity using cosine similarity. Higher scores indicate better alignment between response and source content. The system works together with content coverage and factual consistency scores to evaluate and filter responses, ensuring well-supported information appears in final outputs. The technique proves particularly useful in applications, like processing domain-specific documents, to distinguish between accurate and potentially hallucinated content.

Content coverage scores 314 is a scoring system that evaluates how well language model responses align with source documents by comparing content elements, such as words, phrases, and entities. The system calculates scores by measuring the overlap between response segments and source material, helping identify valid content and potential hallucinations. High scores indicate well-supported content, while low scores suggest content that may deviate from the source. The scores work alongside other metrics, like embedding similarity and factual consistency scores, to filter responses and ensure well-supported content remains.

Factual consistency scores 316 is an evaluation metric that validates language model responses against source documents. The system uses a pre-trained, cross-encoder model to compare individual claims from language model responses with semantically chunked portions of source documents. The system creates a matrix of scores and determines final consistency scores by taking the maximum score across document chunks. Claims below a threshold are filtered out. The system can handle documents up to N (e.g., 20) pages through semantic chunking and works alongside embedding similarity and content coverage scores. The scoring mechanism helps maintain factual accuracy by eliminating hallucinated or incorrect content in the final response.

Segment identification 318 analyzes and evaluates segments from language model responses using three main scoring methods: embedding similarity scores, content coverage scores, and factual consistency evaluation. The system breaks down responses into segments for more detailed assessment rather than analyzing complete responses. The process compares vector representations, content elements, and factual claims between response segments and source documents to identify valid and relevant content that meets scoring thresholds. The evaluation process helps ensure segments are factually accurate and well-grounded in source materials.

The first subset of segments 320 includes language model response segments that have undergone rigorous validation through scoring and filtering. The validation process uses three main scoring mechanisms: embedding similarity scores, content coverage scores, and factual consistency scores. These evaluate how well segments align with source documents semantically, how much content overlaps, and how factually accurate the claims are. Segments are required to meet specific thresholds across these metrics to be included in the subset. This granular, segment-level validation process ensures that verified, accurate content supported by source documents is included, serving as a foundation for generating final responses while filtering out potential inaccuracies.

### 2.3 Input-Specific Segmentation

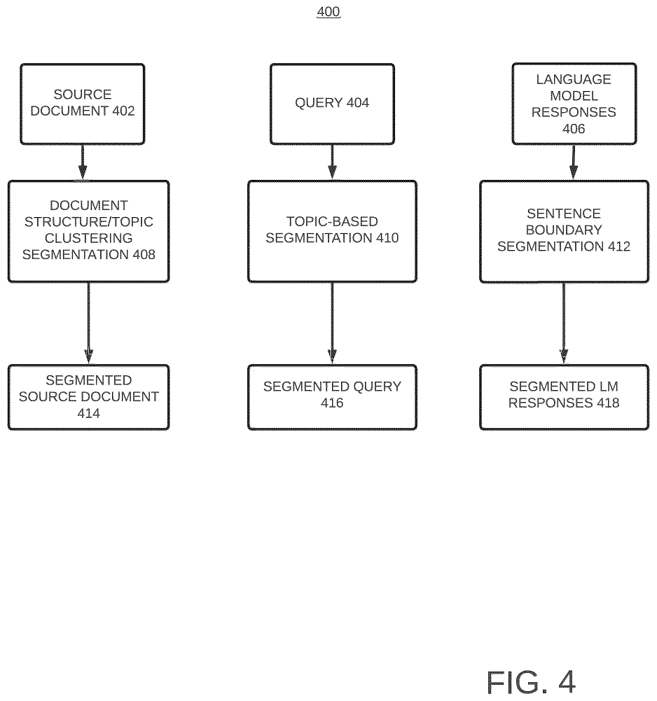

FIG. 4 illustrates a system 400 for segmenting source documents, queries, and language model responses using distinct segmentation strategies based on document structure, topics, and sentence boundaries according to one or more embodiments. The system 400 extends the system and method 100 of FIG. 1. Unless the context clearly indicates otherwise, the system and method 400 can be used in conjunction with or independent of other extensions of the system and method 100 of FIG. 1 described herein with respect to the other figures.

The system 400 segments different inputs using segmentation strategies tailored to an input type. The system segments the source document based on either the document's inherent structure or by grouping related content through topical clustering. The system 400 processes the query by identifying and separating distinct topics within the query text. For the language model responses, the system breaks them down at sentence boundaries to create natural, coherent segments. These segmentation approaches enable the system and method 400 to effectively process the inputs when identifying relevant and valid segments, determining the second subset of segments, ordering them based on their positions, and generating the final response. The segmentation strategies help ensure that an input is broken down in a way that preserves the meaning and structure while facilitating accurate comparison and analysis across the different components of the system.

Source document 402 serves as a reference truth and undergoes segmentation based on the document's structure or content. Two main segmentation approaches are used; for structured documents, the system splits by sections and identifies relevant parts, while unstructured documents undergo chunking with different appropriate window sizes. For these unstructured documents, the system applies topic modeling to determine meaningful segments and dynamically adjusts the chunk sizes based on the strength of identified topic clusters. This segmentation differs from how queries and language model responses are handled, as the process aims to maintain logical organization while enabling effective comparisons.

Query 404 undergoes a segmentation process for handling different types of input content. The system applies distinct approaches for three main content types: language model responses are segmented at sentence boundaries; queries are divided by distinct topics; and source documents are segmented either by structural elements or semantic content using topical clustering. This differentiated approach allows for more precise processing while preserving the original content's organization and meaning.

Language model responses 406 are outputs from multiple language models processing a source document and query. These responses are segmented by sentences to enable detailed analysis. The segmentation differs from other inputs, as queries are segmented by topics and source documents by structure or topical clustering. The sentence-level segmentation allows the system to evaluate a response independently for relevance and validity, helping filter out hallucinations and combine the strongest elements from different language models into a final response. The process enables processing of responses like “b, 3, X, 1” or “Y, 1, 2, c, d, e” from different models analyzing the same input.

Document structure/topic clustering segmentation 408 encompasses a document processing strategy for language models. The system adapts to both structured and unstructured documents: for structured ones, the system splits by existing sections and identifies query-relevant parts; for unstructured documents, the system chunking with different appropriate window sizes, applies topic modeling for segmentation, and adjusts chunk sizes based on cluster strength. The process maintains contextual relationships while efficiently processing large documents. The approach differs from other segmentation methods by considering both physical organization and semantic grouping of content.

Topic-based segmentation 410 serves as an adaptive content processing system that segments different types of input in specific ways. The system handles language model responses by sentence boundaries, queries by topics, and source documents by structure or topical clustering. When processing documents, like construction RFPs, the system segments user queries by topic, breaks down language model responses into sentences, and divides source documents using existing sections or topic modeling. The system adapts the approach based on whether documents are structured (using existing sections) or unstructured (using window sizes and topic clustering). This segmentation method enables better matching between queries and responses, precise content filtering, and proper context validation against source materials.

Sentence boundary segmentation 412 divides language model responses into segments based on sentence boundaries, marked by periods, exclamation points, or question marks. This approach differs from how queries and source documents are processed and serves as the first step in analyzing multiple language model outputs. The segmentation enables independent evaluation of a sentence for relevance and validity, supporting the system's goal of identifying strong content while filtering out weak or hallucinated segments. The segmentation process plays a role in ensuring factual consistency and proper ordering in the final response.

The segmented source document 414 represents a processed version of input documents divided into meaningful segments. For structured documents, segmentation follows natural section boundaries and identifies query-relevant sections. For unstructured documents, the process involves chunking content into appropriate window sizes, performing topic modeling, and clustering to create coherent segments. The segmentation approach differs from how other inputs undergo processing, as the approach considers both document structure and topical relationships to maintain logical organization while enabling effective comparison with language model outputs.

The segmented query 416 is a query processing method that segments user queries based on topics rather than sentences or fixed windows. When a user submits a complex query with multiple topics, the system uses language model calls to identify and separate distinct topics within the query. For example, a construction-related query about both demolition and pre-construction would be split into two separate topical segments. This topical segmentation enables more precise matching between query segments and response segments, leading to more targeted and relevant responses to users' information needs.

Segmented language model responses 418 is a method of breaking down language model outputs into individual sentences for detailed analysis. Unlike other types of text segmentation, this approach specifically targets language model responses to enable better evaluation of claims, detection of hallucinations, and assessment of factual consistency. The system segments different types of content in distinct ways—queries by topics, source documents by structure/topics, and language model responses by sentences. This granular segmentation allows for precise comparison between response segments, source documents, and queries, ultimately helping to create improved final responses by combining and reordering segments from multiple language model outputs.

### 2.4 Response Ordering

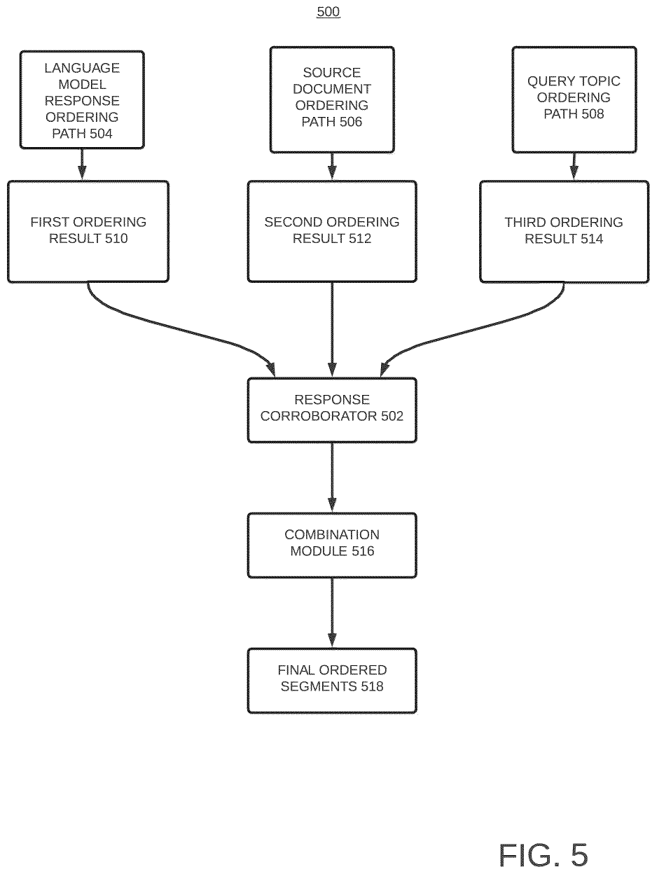

FIG. 5 illustrates a system 500 for combining segment orderings derived from language model responses, source document positions, and query topics to generate ordered text segments according to one or more embodiments. The system 500 extends the system and method 100 of FIG. 1. Unless the context clearly indicates otherwise, the system and method 500 can be used in conjunction with or independent of other extensions of the system and method 100 of FIG. 1 described herein with respect to the other figures.

The system 500 orders segments from language model responses through a multi-faceted approach that considers multiple contextual factors. The system 500 first determines an initial ordering based on where segments appear within the language model responses themselves. The system then creates a second ordering by analyzing the positions of these segments relative to the original source document. The system 500 also examines the query to identify key topics and creates a third ordering based on these identified topics. Finally, the system 500 combines the three orderings—the language model response positioning, source document positioning, and topic-based ordering—to generate a final ordered arrangement of the segments. This comprehensive ordering approach ensures the response maintains logical flow while preserving both the context from the original document and relevance to the query topics. By considering multiple ordering criteria, the system and method 500 produces more coherent and contextually appropriate responses than would be possible using any single ordering approach alone.

Response corroborator 502 determines the optimal order of response segments through a three-step analysis process. The system examines segment positions in language model responses, source documents, and user queries, then combines these signals to create a logical final sequence. The system uses cosine similarity between segment embeddings to match segments across different texts and can adapt the ordering strategy based on source document characteristics, query characteristics, or language model response characteristics. For example, with single-topic queries, the system prioritizes ordering signals from language model responses and source documents over query-based ordering. This approach helps maintain coherence while ensuring optimal arrangement of information in the final response.

The language model response ordering path 504 determines the optimal sequence of response segments using three parallel ordering processes. The system analyzes segment positions from language model responses, examines information structure in source documents, and considers topic sequence from user queries. These signals combine through weighted averaging to create a coherent final response order. The system adapts the strategy based on source document characteristics, query characteristics, or language model response characteristics, adjusting signal weights as needed. For example, with single-topic queries, the system relies more on language model responses and source document ordering rather than query-based ordering. This approach ensures logical structuring of information across different types of source documents, queries, and language model responses.

Source document ordering path 506 represents a method for organizing response segments based on their original positions in source documents. The method uses cosine similarity between segment embeddings to match response segments with their source positions. The path works together with two other ordering signals—language model response positions and query topics—using a weighted average approach that can be adjusted based on source document characteristics, query characteristics, or language model response characteristics. The system helps maintain logical flow and context from the original document while incorporating other ordering considerations and can be used either as part of a complete pipeline or as a standalone component.

The query topic ordering path 508 determines how to order response segments by combining three key signals: language model response ordering, source document ordering, and query topic ordering. The component applies a weighted average approach to combine these signals with weights that can be adjusted based on source document characteristics, query characteristics, or language model response characteristics. The component utilizes cosine similarity between segment embeddings to match segments across different texts and determine their positions. This multi-signal approach ensures logical and coherent sequencing of information in the final response while leveraging various ordering sources.

The first ordering result 510 stands as one of three signals used to determine the final ordering of response segments from language models. The system analyzes how different language models order segments in their responses and uses cosine similarity of embeddings to match corresponding segments across different outputs. This ordering information combines with document structure and query topics to determine the optimal final sequence of segments in the response. The process helps maintain appropriate ordering patterns when different language models present information in varying sequences as demonstrated through a construction document processing example.

The second ordering result 512 is a system for organizing response segments based on their position in source documents. The system uses cosine similarity between embeddings to match response segments with corresponding positions in the original text. The second ordering result represents one of three parallel ordering processes that work together to determine the final arrangement of segments. The system helps maintain logical flow and coherence by preserving the natural ordering of the source material. The process works alongside two other ordering signals-one based on language model response positions and another on query topics. These three signals are combined using weighted averages to create an optimally ordered final response that considers both document structure and query focus.

The third ordering result 514 determines how response segments should be ordered based on topics identified in user queries. The component applies topic modeling to analyze how response segments align with query topics and works alongside two other ordering signals segment positions in language model responses and source document positions. The system can adjust the weight of this ordering result based on source document characteristics, query characteristics, or language model response characteristics. The component helps ensure the final response presents information in a logical sequence that matches user expectations and query structure.

The combination module 516 represents a component that determines the optimal arrangement of text segments in language model responses using three key ordering signals. The module analyzes segment positions from original language model responses, examines segment similarities in source documents, and considers topical progression from queries. The module uses a weighted average approach to combine these signals with weights adjustable based on source document characteristics, query characteristics, or language model response characteristics. For example, when processing single-topic queries, the module reduces query-based ordering weight and relies more on source document and language model response orderings. The module uses cosine similarity between segment embeddings to match segments across reference texts when determining positions, ultimately creating a coherent and logically flowing response while maintaining alignment with source materials.

The final ordered segments 518 is a three-step ordering system that determines the optimal sequence of response segments by analyzing multiple signals. The system combines segment positions from language model responses, source documents, and query topics to create logically structured outputs. The system uses cosine similarity between segment embeddings to match segments across different texts and weighs three key signals: natural flow patterns from language model responses, original content structure from source documents, and topic sequence from user queries. The weighting of these signals adapts based on source document characteristics, query characteristics, or language model response characteristics, such as prioritizing document and language model response ordering for single-topic queries.

### 2.5 Enhanced Query Processing

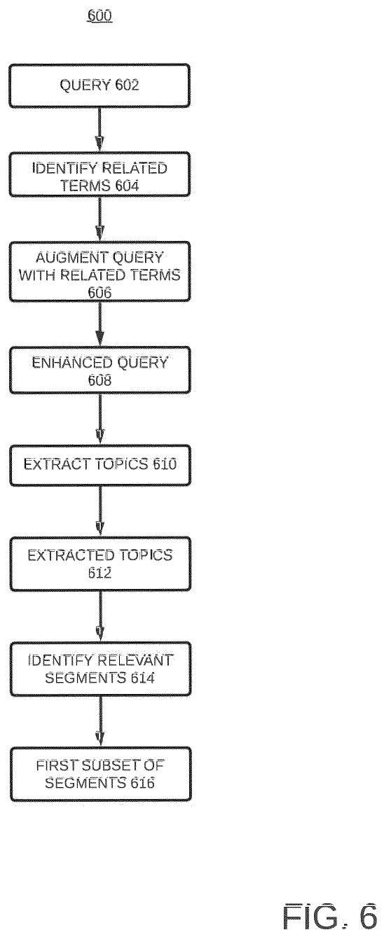

FIG. 6 illustrates a system 600 for enhancing a query with related terms, extracting topics, and identifying relevant segments based on the enhanced query according to one or more embodiments. The system 600 extends the system and method 100 of FIG. 1. Unless the context clearly indicates otherwise, the system and method 600 can be used in conjunction with or independent of other extensions of the system and method 100 of FIG. 1 described herein with respect to the other figures.

The system 600 enhances the identification of relevant segments from language model responses through query expansion and topic analysis. The system 600 first generates an enhanced query by identifying terms related to the original query and augmenting the query with these related terms. For example, if the original query asks about “demolition components”, then enhanced query might be expanded to include terms like “demolition methods” and “site clearing.”

The system 600 then extracts topics from this enhanced query to create a broader semantic framework for relevance assessment. Using both the enhanced query and the extracted topics, the system and method 600 evaluates segments from the language model responses to determine their relevance. This multi-step approach improves the identification of relevant segments by considering direct query matches and semantically related content.

This enhanced processing occurs within the broader context of receiving a source document and query, obtaining multiple language model responses, and validating segments against the source document. The identified relevant segments become part of the first subset that meets both relevance and validity criteria. The system 600 then determines and orders a second subset of segments based on their positions in the source document or language model responses before generating a final response.

Query 602 is a method for enhancing language model response processing by expanding user queries with semantically related terms and key topics. The system uses pre-trained language models to identify related terms and create more comprehensive queries. The method employs topic modeling and zero-shot classification to categorize response segments and determine relevance. Multiple signals, including embedding similarity and content coverage scoring, are used to identify pertinent segments. The method aims to optimize final responses by combining strengths from multiple language models while addressing their individual limitations.

The identify related terms 604 process enhances query processing by identifying semantically related terms to expand query scope. Using a pre-trained language model, the process analyzes original queries and finds related terms based on general language knowledge. For example, a query about “demolition components” might identify terms like “destruction” or “site clearing.” This process helps overcome limitations of short queries by creating more comprehensive comparisons between response segments and query intent. Operating as part of the strength collator component, the system recognizes relevant content even when exact query terms do not match, particularly useful for construction-based documents or any other domain with varied technical terminology. The enhanced queries support subsequent topic extraction and segment identification while maintaining precision in final response generation.

Augment query with related terms 606 is a query enhancement system that expands original user queries by adding semantically related keywords and phrases using pre-trained language models. The system helps create a more comprehensive basis for comparing responses from multiple language models by providing additional context and comparison points. For example, a query about “demolition components” would be expanded to include terms like “demolition methods” and “site clearing.” The augmentation process helps identify relevant responses even when the responses do not exactly match the original query terms and operates without requiring training. The expanded query is then used for further processing steps, like topic extraction and relevance evaluation.

Enhanced query 608 improves language model response relevance through a two-step process. The enhancement system identifies and adds related terms to the original query, creating a more comprehensive search basis. The system uses pre-trained language models to find semantically related terms and performs topic modeling to identify key themes. This enhancement helps overcome minimal query limitations and improves the identification of relevant content, particularly in technical documents where domain-specific terminology plays an important role.

The extract topics 610 component processes enhanced queries to identify key themes and subjects from language model responses. The component uses topic modeling to break queries into distinct themes that then guide segment selection. The extracted topics support zero-shot classification of response segments, including an “other” category. This “other” category may be determined using low-similarity keywords based on minimal semantic relevance to the query. The component works with the strength collator to determine segment relevance using embedding similarity and content coverage scoring. This process helps expand minimal queries and improves the system's ability to identify relevant information while effectively distinguishing between strongly and weakly related content based on similarity metrics.

The extracted topics 612 is a system for improving query processing and response relevance in language models. The system works by first enhancing user queries with semantically related terms, then using topic modeling to extract key themes. These extracted topics are used for zero-shot classification of response segments and measuring topic alignment between queries and responses. The system includes an “other” category to differentiate between directly relevant and less pertinent content, helping to filter responses and ensure responses match the user's information needs more accurately.

The identify relevant segments 614 is a processing operation that identifies relevant segments from language model responses based on user queries. The operation enhances queries by finding related terms and adding them to create comprehensive search targets. The operation involves multiple steps: identifying semantically related terms using pre-trained language models, augmenting the original query with these terms, and extracting topical themes through topic modeling. It uses various relevance signals including embedding similarity, content coverage scoring, topic modeling alignment, and zero-shot classification to evaluate and identify pertinent response segments, even when they include concepts not explicitly mentioned in the original query.

The first subset of segments 616 represents a collection of validated and relevant language model responses. The system identifies these segments through a multi-step process, including:
1. Query enhancement using related terms
2. Multiple evaluation methods including:
   Embedding-based similarity scoring
   Topic modeling
   Zero-shot classification.

The process ensures segments are relevant to the user's query and validated against source documents, helping to eliminate irrelevant or inaccurate content from multiple language model outputs. In an example, a language model1 generates segments “b, 3, 1,” and language model2 generates segments “1, 2, c, d, e” that are then evaluated using the enhanced query process.

To illustrate the terminology used in the example above: segments are labeled with letters (a, b, c, d, e) to represent topically distinct content blocks and numbers (1, 2, 3) to represent factual statements or key points relevant to the user query. The source document contains the following points: a, b, 1, 2, c, d, 3, e. The desired response to the user's summary question should include points 1, 2, and 3 from the source document, in that order. In the language model1 output “b, 3, X, 1,” segment “b” might represent a topic block about demolition methods, “3” could be a factual statement about site preparation, and “1” might be a key point about the site. Segment “X” is about construction duration and is factually not present in the source document. Similarly, in the language model2 output “Y, 1, 2, c, d, e,” segments “1” and “2” represent key points about the site and its preparation, while “c,” “d,” and “e” represent different topical content blocks, such as equipment specifications, environmental considerations, and post-preparation cleanup procedures respectively. Segment “Y” is about environment hazard control and is factually not present in the source document. The weakness limiter processing filters the outputs to (b, 3, 1) and (1, 2, c, d, e) respectively, identifying and removing factually incorrect segments X and Y. The strength collator processing further refines the outputs to (3, 1) and (1, 2), focusing on the key points needed for the response. The response corroborator then receives the combined input (3, 1, 1, 2) and produces the final output (1, 2, 3), arranging the key points in the correct order according to the source document. This processing ensures that even when different language models use varying approaches to organize and present information, the system can effectively identify, validate, and combine relevant content into a coherent response that accurately reflects the information in the source document.

### 2.6 Claim Evaluation

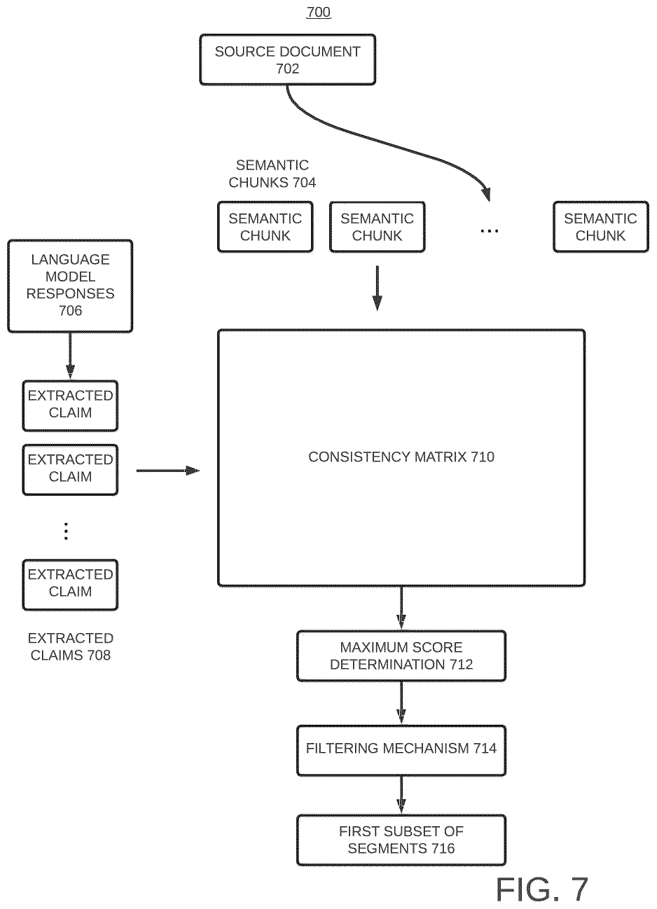

FIG. 7 illustrates a system 700 for evaluating extracted claims from language model responses against semantic chunks to determine consistency scores and identify valid segments according to one or more embodiments. The system 700 extends the system and method 100 of FIG. 1. Unless the context clearly indicates otherwise, the system and method 700 can be used in conjunction with or independent of other extensions of the system and method 100 of FIG. 1 described herein with respect to the other figures.

The system 700 processes language model responses by evaluating consistency between extracted claims and source document content. The system extracts specific claims or statements from segments within the multiple language model responses. The system then divides the source document into semantic chunks, meaningful portions of text that represent distinct ideas or concepts.

The system generates a matrix of consistency scores by systematically evaluating each extracted claim against each semantic chunk from the source document. This evaluation determines how well each claim aligns with or is supported by the source document content. For each extracted claim, the system determines a maximum consistency score from the matrix, representing the strongest alignment between that claim and any semantic chunk.

The system identifies segments for inclusion in the first subset based on the maximum consistency scores of their associated extracted claims. This identification process ensures that the selected segments include claims that are well-supported by the source document. These segments, being both relevant to the query and validated against the source document, then feed into the subsequent steps of determining and ordering a second subset of segments before generating the final response. This systematic evaluation process enhances the reliability and accuracy of the information included in the final generated response.

The system evaluates the factual accuracy of language model responses by comparing the responses to source documents 702. The process involves extracting claims from model responses and breaking source documents into semantic chunks. A cross-encoder model then scores the consistency between claims and chunks, filtering out claims that fall below a threshold score. The system can handle documents up to N (e.g., 20) pages through processing pipelines and semantic chunking, ensuring factually supported claims are retained.

Semantic chunks 704 is a system for dividing source documents into meaningful segments to evaluate the factual consistency of language model responses. The system applies different approaches for structured and unstructured documents; structured documents are split by sections and subsections, while unstructured documents use techniques like fixed window chunking and topic modeling. These chunks serve as reference units to compare claims from language model responses using a cross-encoder model, generating consistency scores to determine if claims should be kept or filtered out. The system enables more precise evaluation by comparing claims against relevant document portions rather than entire documents at once.

Language model responses 706 refers to outputs from multiple language models analyzing a source document and query. The responses are broken down into individual claims for factual verification. The process involves semantic analysis that compares claims against source document chunks using a cross-encoder model to determine consistency scores. The claims undergo evaluation to identify factual versus hallucinated content with the most reliable segments being retained for the final response. The evaluation helps ensure accuracy when processing documents.

A process for evaluating factual consistency in language model responses includes comparing responses to source documents. The system uses a pre-trained, cross-encoder model to break down both language model responses and source documents into smaller units for detailed comparison. The process creates a matrix of consistency scores by comparing extracted claims 708 against semantic chunks of the source document. The system identifies maximum consistency scores for each claim and filters out segments below a threshold to remove potentially hallucinated content. This process is part of a larger weakness limiter stage that includes other evaluation methods, like embedding similarity and content coverage scoring, to ensure accurate output. The consistency matrix structure 710 represents a data organization format used to evaluate factual consistency between language model responses and source documents. The structure creates a grid where extracted claims from language model responses are compared against semantic chunks of the source document, generating consistency scores. The matrix enables efficient comparison by organizing claims on one axis and document chunks on another. For example, a 3×4 matrix would compare three claims against four document chunks. The system uses this matrix to find maximum consistency scores for each claim across semantic chunks, helping identify well-supported claims efficiently, particularly in longer documents.

Maximum score determination 712 evaluates the factual consistency of claims from language model responses by comparing these claims against source documents. The system creates a matrix of consistency scores by comparing each claim against relevant document chunks using a cross-encoder model trained on factual consistency data. The highest consistency score across comparisons becomes the final score for each claim. Claims scoring above a predetermined threshold are retained, while others are filtered out. This approach helps ensure factual accuracy by keeping well-supported claims in the final response. The system proves particularly useful for processing large documents and filtering out incorrect or hallucinated content.

A filtering mechanism 714 is designed to evaluate factual consistency in language model responses. The filtering mechanism works by breaking down language model responses into individual claims and dividing source documents into semantic chunks. The filtering mechanism uses a cross-encoder model trained on factual consistency data to create a scoring matrix comparing claims against source chunks. The system determines validity by finding maximum consistency scores across document chunks and filters out claims below a threshold. The filtering mechanism can handle documents up to N (e.g., 20) pages long, improving upon basic cross-encoder models that process shorter texts, ultimately ensuring factually supported claims appear in final outputs.

A factual consistency scoring process for validating language model responses against source documents breaks down both responses and source documents into smaller segments for detailed comparison. A cross-encoder model, pre-trained on factual consistency data, evaluates each claim against relevant source document chunks by creating a comparison matrix. The system can recognize factually consistent statements even when worded differently. Only segments meeting a predetermined consistency threshold are included in the first subset of segments 716, ensuring the final response includes well-supported information and eliminates potential hallucinations.

### 2.7 Parallel Processing

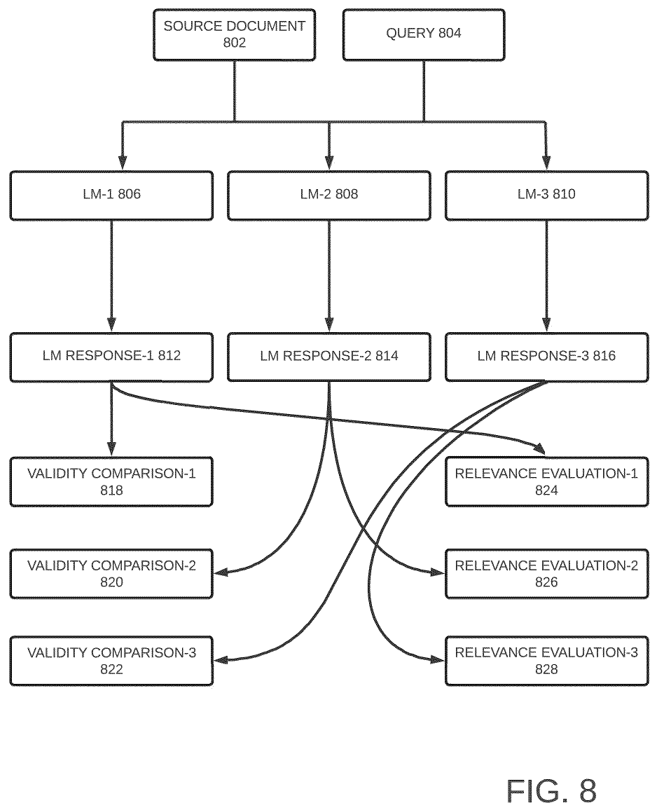

FIG. 8 illustrates a system 800 for parallel processing of source documents using multiple language models and performing simultaneous validity and relevance evaluations according to one or more embodiments. The system 800 extends the system and method 100 of FIG. 1. Unless the context clearly indicates otherwise, the system and method 800 can be used in conjunction with or independent of other extensions of the system and method 100 of FIG. 1 described herein with respect to the other figures.

The system 800 processes source documents and queries using multiple language models in parallel to improve processing efficiency. When obtaining language model responses, the system and method 800 simultaneously sends the source document and query to multiple language models for concurrent processing. This parallel processing approach enables the system to gather responses from different language models without waiting for sequential processing completion.

The system 800 then performs two types of parallel evaluations on the language model responses. One, the system simultaneously compares segments from the language model responses against the source document to verify their validity. Two, the system concurrently evaluates these segments against the original query to determine their relevance. This dual parallel processing approach allows the system and method 800 to efficiently identify segments that are valid and relevant to the query. The parallel nature of these comparisons and evaluations enhances the overall processing speed compared to sequential processing methods.

These parallel processing steps feed into the broader process of identifying valid and relevant segments, determining and ordering a refined subset of segments, and generating a final response as described in the parent method. The parallel implementation specifically optimizes the response generation and validation steps without changing the fundamental operation or output quality.

A source document input component 802 serves as an entry point for processing various types of documents using multiple language models in parallel. The system can handle different content types, including construction documents up to N (e.g., 20) pages long, chat logs, and other formats. The system works with parallel processing across different language model versions, enabling cost-effective use of multiple smaller models rather than one large model. The system segments input documents based on structure or topic modeling and performs parallel validity comparisons between language model responses and source segments. This parallel architecture improves scalability, while the use of pre-trained models without fine-tuning achieves significant cost savings (e.g., up to 40× reduction in GPU costs compared to approaches requiring model fine-tuning) while maintaining quality through ensemble processing. The query input box 804 serves as a user interface component that allows users to enter queries for parallel processing alongside source documents. The query input box functions as one of two primary inputs in the parallel processing workflow and can handle various types of requests, like summarization and synthesis. The system uses pre-trained language models to augment short queries with related keywords for better comparison, enabling flexible interaction with multiple language models while maintaining parallel processing capabilities.

Language model 806 serves as a component in a parallel processing architecture that uses multiple language models simultaneously to process documents and queries. The system runs different versions of language models concurrently to generate responses, perform validity checks, and evaluate relevance. The parallel architecture improves efficiency by using multiple smaller models instead of one large model, resulting in significant cost savings while maintaining quality. The overall latency of the system depends on the slowest model in the ensemble.

Language model 808 processes documents and queries in parallel with other language models for improved efficiency. Multiple models run simultaneously rather than sequentially, reducing latency while maintaining performance. The parallel processing includes both response generation and evaluation, where responses are compared against source documents and queries for validity and relevance. The architecture optimizes performance while using multiple smaller, cost-effective models instead of one large model.

A parallel processing system uses multiple language models (referred to as language model 810) that work simultaneously rather than sequentially. Different versions of language models work together to leverage the individual strengths of a model in processing different types of content. This parallel architecture achieves significant cost savings (e.g., up to 40× reduction) compared to using a single, fine-tuned model while maintaining good performance. The parallel processing extends to validity checking and relevance evaluations though overall system speed remains limited by the slowest model in the parallel setup.

A parallel processing approach for language model responses 812, 814, and 816 uses multiple language models simultaneously to process documents and queries. The parallel processing extends to validity checking and relevance evaluation stages, where response segments are compared against source documents and queries concurrently. The parallel approach maintains efficiency despite multiple processing steps as the generation time of language models dominates the total processing time. The system represents improvement over sequential processing by enabling simultaneous operations while maintaining output quality and cost-effectiveness.

Parallel processing of language model responses 812, 814, and 816 uses multiple language models simultaneously. Multiple models process the same source document and query to generate individual responses that are then used in an ensemble approach for creating enhanced summaries. The parallel processing occurs during both response generation and evaluation phases, where responses are checked against source documents for validity and queries for relevance. The architecture maintains efficiency despite using multiple models and helps optimize performance while keeping latency reasonable because processing time depends on the slowest model rather than being cumulative across multiple models.

Multiple language models simultaneously analyze the same input document and query to generate responses. These responses 812, 814, and 816 undergo parallel comparisons and evaluations to check validity against source documents and query relevance. The system uses models to analyze documents simultaneously with different models potentially extracting different types of information. The parallel architecture incorporates validity checks through embedding similarity scores, content coverage, and factual consistency, while relevance undergoes evaluation through embedding-based similarity scoring, topic modeling, and zero-shot classification. This approach maintains efficiency by having processing time determined by the slowest model rather than cumulative processing times.

Validity comparisons 818, 820, and 822 perform parallel comparisons between language model responses 812, 814, and 816 and source document 802. This component uses multiple validation techniques, including embedding similarity comparison, content coverage scoring, and fact scoring using cross-encoder models. The comparison block processes multiple language model outputs simultaneously at a segment level, allowing for efficient and granular validation. The system uses predetermined thresholds to filter out problematic content while keeping segments that are properly supported by the source document. The parallel nature enables efficient processing of multiple outputs while ensuring thorough validation against source materials.

Validity comparisons 818, 820, and 822 perform parallel validity checks between source document 802 and language model responses 812, 814, and 816, respectively, to identify and remove incorrect content. The block uses multiple methods, including embedding similarity scores, content coverage analysis, and a cross-encoder model to assess factual consistency. The parallel processing capability allows simultaneous evaluation of multiple response segments against the source document, significantly improving efficiency compared to sequential processing. The validity comparison block represents an innovation for effectively combining multiple language model outputs while maintaining accuracy in content validation.

Validity comparison 818, 820, and 822 performs parallel comparisons between source document 802 and language model responses 812, 814, and 816, respectively, to verify accuracy. The validity comparisons use multiple similarity checks, including embedding similarity, content coverage, and factual consistency scores. The system employs a cross-encoder model trained on factual consistency data and breaks down both source documents and responses into segments for granular analysis. The validity comparisons process these segments in parallel, comparing words, phrases, and entities, to identify commonalities and filter out inaccurate content, creating a matrix of comparison scores for efficient processing.

Relevance evaluations 824, 826, and 828 perform parallel evaluations between user query 804 and language model responses 812, 814, and 816, respectively. The relevance evaluations use a strength collator component to compare response segments against augmented versions of user questions. The evaluation process involves multiple simultaneous techniques, including embedding similarity scoring, content coverage scoring, topic modeling alignment, and zero-shot classification. The system augments short user queries with related keywords using a pre-trained language model. The parallel processing architecture allows for efficient simultaneous evaluation of multiple response segments while maintaining comprehensive relevance assessment through concurrent evaluation methods.

Relevance evaluations 824, 826, and 828 perform parallel assessments of user query 804 against language model responses 812, 814, and 816, respectively. The system uses multiple techniques, including embedding-based similarity scoring, topic modeling, and zero-shot classification, to determine relevance. The system augments short user questions with related keywords using a pre-trained language model to enable better comparison. The evaluation process combines various signals, like embedding similarity, content coverage, and topic alignment, to identify the most pertinent response segments. The parallel processing nature allows for efficient evaluation while maintaining thoroughness.

Relevance evaluations 824, 826, and 828 assess the relevance between user query 804 and language model responses 812, 814, and 816, respectively, in parallel. The component uses multiple evaluation methods, including embedding similarity comparisons, content coverage scoring, topic modeling, and zero-shot classification. The system augments short user queries with related keywords for better comparison and categorizes response segments according to query topics. The evaluations operate alongside validity checks to ensure relevance and accuracy, combining multiple signals to identify the most pertinent response segments even those with implicit concepts not directly mentioned in the original query.

### 2.8 Weighted Ordering

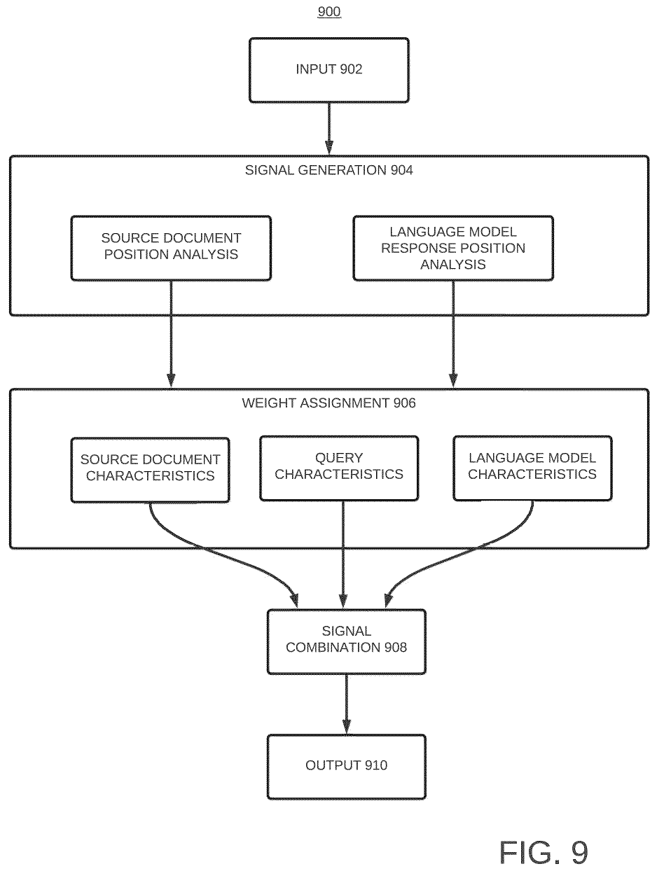

FIG. 9 illustrates a system 900 for generating an ordered subset of segments by combining weighted, position-based signals from source documents and language model responses according to one or more embodiments. The system 900 extends the system and method 100 of FIG. 1. Unless the context clearly indicates otherwise, the system and method 900 can be used in conjunction with or independent of other extensions of the system and method 100 of FIG. 1 described herein with respect to the other figures.

The system 900 processes the second subset of segments to determine their optimal ordering by utilizing a weighted signal approach. The system generates multiple ordering signals by analyzing how the segments are positioned within both the source document and the language model responses. The system then assigns specific weights to these ordering signals based on various characteristics drawn from the source document, the query, and/or the language model responses. The system combines these weighted ordering signals to produce the final ordered arrangement of the second subset of segments. This ordering process enhances the earlier steps of the system and method 900 where the source document and query are processed by multiple language models, relevant and valid segments are identified, and a second subset of segments is determined. By incorporating weighted, position-based signals, the system creates a more contextually appropriate and logically structured response that better reflects the relationships between segments as they appear in both the original source material and the language model outputs.

The input block 902 processes multiple ordering signals to determine optimal arrangement of response segments. The input block analyzes segment positions in source documents and language model responses to generate weighted ordering signals. The component uses a weighting mechanism that adapts based on source document characteristics, query characteristics, or language model response characteristics, assigning different weights depending on factors, like document structure and query complexity. The component combines ordering signals from three main sources—language model responses, source document structure, and user query topics—using weighted averages to produce a coherent final sequence. When handling construction documents, for example, the input block analyzes how different language models order construction phases while considering the original document sequence.

The signal generation 904 analyzes how text segments appear in different source materials to create multiple ordering signals. The signal generation examines segment positions in source documents and language model responses to identify sequence patterns. The block generates distinct signals from these sources to capture different ordering aspects, using examples, like numbered segments, from different language model outputs. Working with pre-filtered segments, the signal generation helps determine logical ordering in the final response as part of a larger ordering system that uses signals and weights.

The weight assignment 906 is a component that determines the importance of different ordering signals when sequencing response segments. The weight assignment block evaluates source documents, user queries, and language model responses to assign appropriate weights. For queries with a single topic, the weight assignment block gives less weight to query-based ordering and more weight to document and language model-based ordering patterns. The system functions as part of a larger ordering mechanism that analyzes segment patterns across reference texts with weights being optimized through training data to produce the most effective ordering combinations for various input types.

The signal combination 908 is a component that combines multiple ordering signals to determine the optimal sequence of response segments. The block processes various ordering signals from language model responses, source documents, and user queries, applying weights based on source document characteristics, query characteristics, or language model response characteristics. The block analyzes segment positions across different reference sources and combines this information to produce a coherent final ordering. The weights can be optimized using training data, allowing the system to adapt the ordering strategy based on specific source document characteristics, query characteristics, or language model response characteristics while maintaining logical flow in the response.

Output block 910 is a component that manages text segment ordering in a language model ensemble system by combining multiple ordering signals from three sources: language model responses, source documents, and user questions. The component uses a weighted average approach that can be adjusted based on source document characteristics, query characteristics, or language model response characteristics, making the approach more adaptable than traditional, single-source ordering methods. For example, when processing single-topic queries, the component relies more on language model responses and source document patterns rather than query-based ordering.

### 2.9 Language Model Response Processing

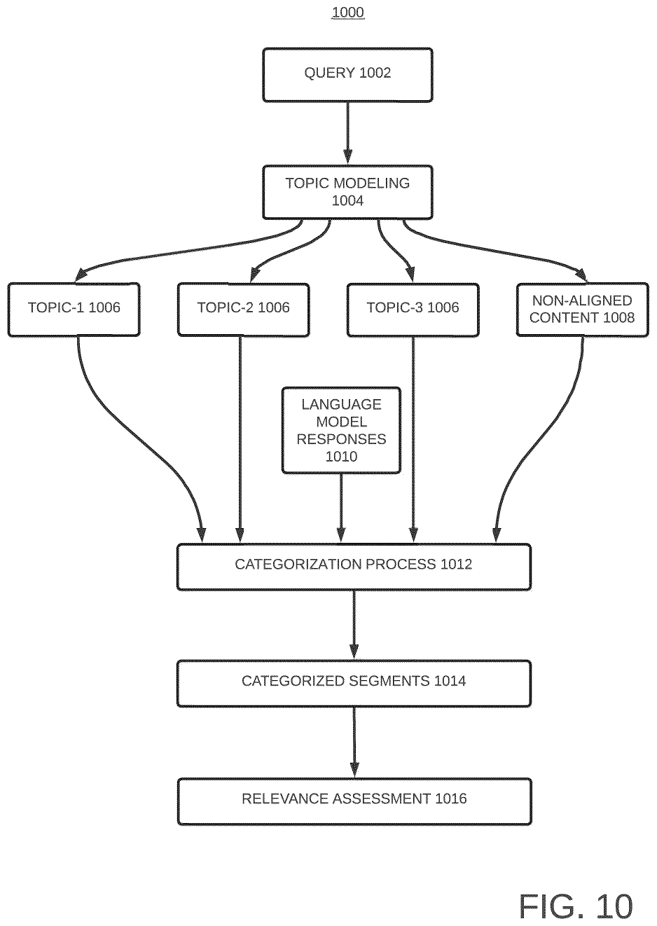

FIG. 10 illustrates a system 1000 for processing language model responses through topic modeling, categorizing segments according to extracted topics, and identifying relevant query-aligned content according to one or more embodiments. The system 1000 extends the system and method 100 of FIG. 1. Unless the context clearly indicates otherwise, the system and method 1000 can be used in conjunction with or independent of other extensions of the system and method 100 of FIG. 1 described herein with respect to the other figures.

The system 1000 processes language model responses by performing topic-based analysis and categorization. The system extracts topics from the received query using topic modeling techniques. The system then creates an additional category to handle any content that does not align with the extracted topics. The system categorizes segments from the language model responses by sorting them into the extracted topic categories and the additional catch-all category. The system identifies segments as query-relevant based on how well they align with the extracted topics and their assigned categorization. This topic-based processing helps determine the segments from the language model responses that are both relevant to the query and valid based on the source document, forming the first subset of segments. The system then uses this first subset to determine and order a second subset of segments based on their positions in the source document or language model responses. Finally, the system generates a response using the ordered second subset of segments.

The system extracts topics from user queries and creates an additional catch-all category for content not aligned with main topics. Multiple language model responses are categorized according to these topics and the extra category. Query relevance is determined by how well segments align with extracted topics.

In implementation, a strength collator component uses topic modeling to extract key themes from queries. The system employs both topic modeling and zero-shot classification for categorization with an “other” category for factually correct but less relevant segments. This category is identified through keywords with low similarity to query topics. The process combines multiple relevance signals to identify the most query-relevant segments, allowing for comprehensive responses that maintain relevance to user needs.

Query 1002 is an input component that helps guide system analysis and filtering of language model responses. Query 1002 undergoes topic modeling to identify key themes and establish relevance criteria. The system uses Query 1002 for strength collation through topic modeling and zero-shot classification to categorize response segments. The system creates an “other” category for less relevant segments. Query 1002 serves as a reference point for evaluating segments using multiple signals like embedding similarity, content coverage scoring, and topic alignment to identify the most relevant responses.

Topic modeling 1004 is a process for analyzing and categorizing language model responses based on query-relevant topics. The process extracts key themes from user queries and includes a unique “other” category for content that is factually correct but less relevant. The process categorizes response segments according to extracted topics and uses topic alignment analysis to identify the most relevant segments for inclusion in final responses. This approach helps maintain focus on the user's intended query topics while systematically handling less relevant information within the larger framework of language model response processing.

Extracted topics 1006 is a topic modeling system that identifies key themes from user queries to evaluate language model response relevance. The system breaks down queries into distinct topics and uses them as reference points for assessing response segments. The system includes an additional category mechanism for content not directly aligned with main topics, ensuring comprehensive coverage. This approach is useful for complex queries with multiple aspects helping to ensure responses address key query components while maintaining coherence.

Non-aligned content 1008 is a processing step in combining language model responses that handles content not directly aligned with main query topics. The process uses zero-shot classification to identify and group keywords with low similarity to query topics. This category acts as a safety net to capture tangentially related but still relevant information that might otherwise be filtered out by strict topic matching. For example, in construction documents, the category might capture site preparation details when the query focuses on demolition. This approach helps maintain comprehensive responses while preserving focus on the query's primary intent.

Language model responses 1010 are output text segments generated by multiple language models when processing source documents and queries. These responses undergo topic-based categorization and evaluation to determine their relevance. Using topic modeling, the system extracts topics from user queries and creates an “other” category for content not directly aligned with main topics. The relevance of responses undergoes evaluation through multiple signals, including embedding similarity, content coverage scoring, topic modeling alignment, and zero-shot classification. This approach ensures meaningful segments that address the user's question are included in the final response.

Categorization process 1012 is for analyzing and categorizing language model response segments. The process begins with topic extraction from user queries and creates categories with an “other” category for less relevant content. The process uses a transformer-based, zero-shot classification model and evaluates responses using multiple signals, such as embedding similarity, content coverage scoring, topic modeling alignment, and classification results. The process works within the strength collator component after the weakness limiter stage, ensuring factually correct content undergoes categorization. This approach helps determine the segments to retain in final responses based on relevance to query topics.

Categorized segments 1014 help improve language model responses by classifying text segments into relevant topics. The system extracts key themes from user queries and adds an “other” category for less relevant content. Through zero-shot classification with a transformer model, segments from language model responses are sorted into these categories. The categorization helps determine the content that has most relevance to the query and should be included in final responses, working together with other metrics, like embedding similarity and content coverage scoring.

Relevance assessment 1016 evaluates how relevant language model responses are to user queries through topic analysis. The assessment extracts topics from queries and includes an “other” category for content not directly related to main topics. The system categorizes response segments using zero-shot classification with a transformer model rather than a general language model. The assessment functions as part of a strength collator component that combines various relevance signals to identify the most pertinent response segments and ensure accurate, relevant answers to user queries.

### 3.0 EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

In one or more embodiments, a source document comprising a twenty-page construction project RFP document and a user query requesting information about demolition components are received as inputs. These inputs are processed through multiple language models.

A language model generates a complete response based on the source document and query. For example, the first language model might generate a response highlighting certain demolition requirements and specifications, while the second language model might generate a response emphasizing different aspects of the demolition scope and timeline.

These language model responses are then processed by breaking them into segments. For a segment, validity checks are performed by comparing the segment content against the source document. This comparison involves calculating similarity scores between the segment and the source document, measuring content coverage, and evaluating factual consistency. Segments that fail to meet predetermined threshold scores are filtered out to ensure the remaining segments are properly grounded in the source material.

A segment's relevance to the demolition-related query is evaluated. This evaluation includes analyzing topic alignment and calculating similarity scores between the segments and the query. Through this process, segments that are both valid (based on source document comparison) and relevant to the demolition information request are identified.

After identifying the valid and relevant segments, their relative positions within both the original language model responses and the source document are analyzed. For instance, if certain demolition requirements are described in a specific sequence in the source document, this ordering information helps determine the proper arrangement of segments in the final response.

These segments are then combined in the determined order to generate a cohesive final response. For example, the final response might begin with segments describing the general demolition scope from one language model followed by segments detailing specific requirements from another language model, all arranged to maintain a logical flow of information that matches patterns found in the source document and original responses.

Through this process, the final response effectively combines the strongest elements from both language models while maintaining accuracy and proper organization. If one language model better captured certain demolition requirements while the other better described timeline considerations, the final response incorporates these respective strengths while filtering out any inconsistent or irrelevant content.

### 4. PRACTICAL APPLICATIONS, ADVANTAGES, AND IMPROVEMENTS

One or more embodiments can be deployed in various enterprise settings where accurate processing of large documents is useful. For example, one or more embodiments can analyze construction project RFP documents to extract specific information about components, like demolition or pre-construction requirements. One or more embodiments are particularly valuable for organizations that need to process and summarize substantial documents (e.g., 20+ pages) while maintaining high accuracy and relevance to specific queries.

One or more embodiments can be implemented either as an internal tool within an organization or as a customer-facing solution. One or more embodiments can be deployed as a complete standalone system or integrated into existing workflows through an interface-based service. This flexibility makes one or more embodiments suitable for diverse applications across industries where document analysis and query response generation are needed.

A significant advantage of one or more embodiments is the substantial cost reduction compared to traditional approaches. By using multiple smaller language models in parallel instead of a single, large model, one or more embodiments can reduce GPU costs by up to 40 times compared to hosting a fine-tuned model. This makes sophisticated language model capabilities accessible to organizations with budget constraints or lower-volume use cases that could not justify the ROI of traditional, fine-tuning approaches.

One or more embodiments eliminate the need for domain-specific training data, reducing development time and complexity. Since one or more embodiments operate in an unsupervised manner without requiring model fine-tuning, organizations can easily adapt one or more embodiments to new domains without investing in data collection and annotation efforts typically needed for fine-tuning approaches.

One or more embodiments maintain flexibility by allowing organizations to select and combine their preferred language models rather than being locked into a predetermined set of models. This enables organizations to update and modify their model selections as new options become available or as their needs change.

One or more embodiments improve upon existing solutions by processing responses at a segment level rather than as complete units. This granular approach enables more precise identification and handling of both strong and weak elements within responses, leading to higher quality final outputs compared to approaches that select complete responses from individual models.

One or more embodiments enhance accuracy by implementing multiple validation checks against source documents while maintaining efficiency through parallel processing. Even though additional processing steps are added through the pipeline, the overall latency is not necessarily increased compared to using a single large model, for the generation time of large models tends to dominate total processing time.

One or more embodiments improve scalability and accessibility of advanced language model capabilities. By enabling the use of multiple, smaller, more resource-efficient models in combination to produce results comparable to larger, more complex models, one or more embodiments make sophisticated document processing capabilities available to a broader range of organizations and use cases.

One or more embodiments provide improved comprehensiveness in responses by leveraging the diverse strengths of multiple models while minimizing their individual weaknesses. This results in more reliable and complete responses compared to single-model approaches, as demonstrated through experimental results showing higher cosine similarity scores and better content coverage compared to ground truth summaries.

### 5. EXAMPLE LANGUAGE MODEL ARCHITECTURE

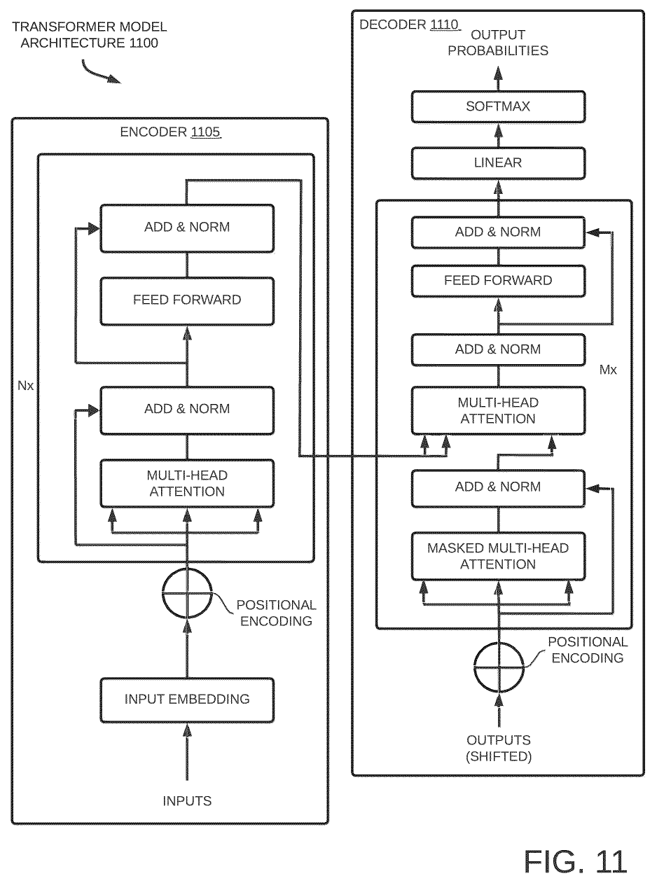

FIG. 11 illustrates an example transformer model architecture 1100 that may be used in the implementation of a language model according to one or embodiments of the present disclosure.

The transformer model architecture 1100 may be a neural network design for natural language processing. At its core, the architecture 1100 may encompass an encoder 1105 and a decoder 1110, both leveraging self-attention mechanisms. The architecture 1100 may begin with an input embedding layer that converts tokens into high-dimensional vector representations that may range, for example, from 128 to 1024 dimensions. These embeddings may be augmented with positional encodings to retain sequence order information.

The transformer model architecture 1100's input embedding layer serves as the initial processing stage for converting discrete tokens into continuous vector representations. These dense embeddings may occupy a high-dimensional space, with dimensionality configurations ranging from 128 to 1024, allowing for rich semantic representation of input tokens. The embedding process maps a token to a unique vector that captures the token's semantic properties in the continuous space. Positional encodings are subsequently added to these token embeddings through element-wise addition, introducing position-dependent signals that encode sequential information. These positional encodings can be implemented using sinusoidal functions or learned parameters, enabling the model to differentiate between tokens based on their positions in the sequence. The combined embeddings preserve both semantic content and sequential order, forming a foundation for the subsequent self-attention mechanisms. This embedding strategy addresses the inherent limitation of transformer architectures in processing sequential data, as the self-attention mechanism alone is position-agnostic.

The architecture 1100 may include a multi-head, self-attention mechanism. This may allow the architecture 1100 to simultaneously attend to different parts of the input sequence, capturing various types of relationships and dependencies. An attention head may compute query, key, and value vectors, enabling the model to focus on relevant parts of the input when processing a token. Following the attention layers, the architecture 1100 may incorporate feed-forward neural networks with multiple layers and non-linear activation functions.

The multi-head self-attention mechanism forms a component of the transformer architecture 1100, enabling parallel processing of input sequence elements. An attention head operates as an independent attention mechanism, computing three distinct matrices: queries (Q), keys (K), and values (V) through learned linear transformations of the input embeddings. The parallel nature of multiple attention heads allows the model to capture diverse relationship patterns within the same input sequence simultaneously, such as syntactic dependencies, semantic relationships, and long-range contextual connections. The attention computation follows the scaled dot-product attention formula, where the dot product between queries and keys determines alignment scores, followed by scaling and softmax normalization to produce attention weights. These weights are then applied to the value vectors, creating context-aware representations. The feed-forward neural networks following the attention layers include two linear transformations with a non-linear activation function (e.g., ReLU or GELU) between them, processing a position's output independently. This combination of self-attention and position-wise feed-forward networks enables the model to alternate between gathering contextual information across the sequence and applying complex transformations to individual positions, creating a powerful mechanism for sequence processing.

A masked, multi-head attention mechanism in the decoder 1110 of a transformer architecture 1100 may be designed to prevent the model from attending to future tokens during sequence generation. In this mechanism, multiple attention heads may operate in parallel, a computing query (Q), key (K), and value (V) matrices from the input embeddings. The attention scores may be calculated as the dot product of Q and K, scaled by the inverse square root of the dimension of the keys. A lower triangular mask may be applied to these attention scores before softmax normalization, effectively setting the upper triangular elements to negative infinity. This masking may ensure that a position can attend to previous positions in the sequence, maintaining the autoregressive property of the decoder. The masked attention scores may then be used to compute a weighted sum of the value vectors. The outputs from the heads may be concatenated and linearly transformed to produce the attention output. This process may allow the decoder to generate tokens sequentially while considering the previously generated tokens, thus preserving the causal nature of language modeling.

The masked multi-head attention mechanism in the transformer's decoder 1110 implements causal masking to enforce autoregressive generation during sequence processing. An attention head performs linear projections to create query (Q), key (K), and value (V) matrices from input embeddings through learned weight matrices WQ, WK, and WV respectively. The attention computation follows the formula Attention (Q, K, V)=softmax(QK^{T}/√dk)V, where dk represents the dimensionality of the key vectors. A lower triangular mask matrix gets added to the attention scores before softmax normalization. This mask sets all upper triangular elements to negative infinity (−∞), effectively zeroing out these positions after the softmax operation. The masking operation ensures strict causality by preventing any position from attending to future positions in the sequence during both training and inference. Following the masked attention computation, the outputs from multiple attention heads are concatenated along the feature dimension and projected through a final linear transformation WO to produce the layer's output. This output maintains the temporal causality required for autoregressive generation while still allowing a position to attend to all previous positions in the sequence. The parallelized implementation of multiple attention heads enables the model to capture various aspects of the sequence history simultaneously, while the masking mechanism maintains the sequential nature of language generation.

To maintain stable training and mitigate vanishing gradients, the architecture 1100 may employ layer normalization after a sub-layer (self-attention and feed-forward networks) and may introduce residual connections. These residual connections may allow unimpeded information flow through the network. The model may include multiple (Nx) encoder and decoder (Mx) layers stacked on top of each other, increasing its capacity to learn complex language patterns.

The transformer architecture incorporates stabilization techniques through layer normalization and residual connections. Layer normalization is applied after both the self-attention and feed-forward network sub-layers, normalizing the activations across the feature dimension for a token position. The normalization process computes the mean and variance of the features, then scales and shifts the normalized values using learned parameters gamma and beta, effectively standardizing the feature distributions throughout the network. Residual connections, implemented as skip connections, add the input of a sub-layer to the transformed output, creating direct paths for gradient flow during backpropagation. The combination of these components follows the formula LayerNorm(x+Sublayer(x)), where x represents the input and Sublayer represents either the self-attention or feed-forward network.

The stacking of multiple encoder and decoder layers increases the model's capacity logarithmically with respect to sequence length, enabling the capture of hierarchical patterns in language. An additional layer in the stack provides an opportunity for more abstract feature representation, with lower layers capturing local patterns and higher layers learning more complex, global dependencies. The interaction between layer normalization and residual connections creates a well-conditioned optimization landscape, facilitating stable training of deep transformer networks while mitigating the vanishing gradient problem that commonly affects deep neural architectures.

The output layer may involve a linear transformation followed by a softmax function, producing probability distributions over the vocabulary for text generation tasks. This architecture 1100's design may allow for efficient parallel processing of input sequences, making it particularly suitable for handling the extensive datasets used in training language models.

The output layer of the transformer architecture implements a vocabulary-sized classification mechanism through a linear transformation followed by softmax activation. The linear transformation projects the decoder's hidden states onto a vocabulary-sized space using a weight matrix W∈ [symbol] \hat{ }(d_model×|V|), where d_model represents the model's hidden dimension and |V| represents the vocabulary size. The subsequent softmax function normalizes these logits into a proper probability distribution across the entire vocabulary, computing P(token_i)=exp(z_i)/Σ_j exp(z_j), where z_i represents the logit for the i-th vocabulary token. This architectural design enables efficient batch processing of input sequences through matrix multiplications, leveraging modern hardware accelerators like GPUs and TPUs. The parallel computation capability stems from the self-attention mechanism's ability to process all sequence positions simultaneously during the forward pass, requiring O(1) sequential operations compared to the O(n) operations needed in recurrent architectures. The model's parallelization efficiency scales particularly well with increasing sequence lengths, making the architecture advantageous for processing the extensive datasets used in large language model training, that often include billions of tokens across diverse domains and languages.

In one or more embodiments, architectural variations enhance or modify the standard transformer design for language model implementations. The Sparse Transformer introduces structured sparsity patterns in the attention mechanism, reducing the quadratic memory complexity to linear complexity through fixed attention patterns. This modification enables processing of much longer sequences while maintaining model quality. Reformer architectures employ locality-sensitive hashing for attention computation, approximating full attention while significantly reducing memory requirements. The Performer architecture replaces the attention mechanism with kernel-based formulations using random feature decomposition, achieving linear complexity in both compute and memory.

Alternate positional encoding schemes offer various trade-offs. Rotary positional embeddings (RoPE) inject positional information through rotation matrices applied to token embeddings, providing better relative position modeling. Alibi position embeddings add learned bias terms to attention scores, enabling better extrapolation to sequences longer than those seen during training. Some architectures eliminate explicit positional encodings entirely, instead relying on position-aware linear attention mechanisms.

Architecture modifications also target specific computational bottlenecks. Flash Attention optimizes attention computation through careful management of GPU memory access patterns. Mixture of Experts (MoE) architectures incorporate sub-networks activated based on input patterns, increasing model capacity without proportional computation increases. The GLU (Gated Linear Unit) variants replace standard feed-forward networks with gated mechanisms, providing more flexible function approximation. Multi-query attention reduces memory bandwidth requirements by sharing key and value projections across attention heads while maintaining separate query projections.

Some architectures focus on improved training dynamics. DeepNorm modifies the layer normalization scheme to enable stable training of deeper networks. Gradient checkpointing strategies reduce memory requirements during training by recomputing certain activations during backpropagation. State space models offer an alternative to attention mechanisms entirely, using linear state space equations to model sequence relationships with improved computational efficiency.

Alternative architectures for language model implementation encompass distinct paradigms beyond transformers. Recurrent Neural Networks (RNNs), particularly variants like Long Short-Term Memory (LSTM) networks and Gated Recurrent Units (GRUs), process sequences sequentially through hidden state updates. These architectures maintain explicit temporal dependencies through gating mechanisms, controlling information flow between timesteps. LSTM networks employ three gates—input, forget, and output—along with a memory cell to regulate information persistence. GRUs simplify this structure with reset and update gates while maintaining comparable performance.

Convolutional Neural Networks (CNNs) offer another approach through hierarchical feature extraction. Temporal Convolutional Networks (TCNs) apply dilated convolutions to capture long-range dependencies while maintaining autoregressive properties. The hierarchical structure of TCNs enables parallel processing within a layer while preserving causal relationships. Quasi-Recurrent Neural Networks (QRNNs) combine convolutional and recurrent approaches, using convolution for parallel feature extraction followed by a lightweight recurrent pooling mechanism.

Memory-augmented architectures present another paradigm. Neural Turing Machines (NTMs) and Differentiable Neural Computers (DNCs) supplement neural processing with external memory arrays, accessed through attention-like mechanisms. These architectures separate computation from memory storage, enabling more explicit modeling of long-term dependencies. Memory Networks similarly incorporate dedicated memory components but with more structured addressing mechanisms.

Continuous-time models offer an alternative perspective on sequence processing. Neural Ordinary Differential Equations (Neural ODEs) model sequence evolution as a continuous-time dynamical system, solving differential equations to process inputs. This approach enables variable timestep processing and potentially more natural handling of temporal relationships. Similarly, Neural Controlled Differential Equations (Neural CDEs) extend this framework to handle irregular time series data while maintaining end-to-end differentiability.

Graph Neural Networks (GNNs) provide yet another alternative by modeling sequences as structured graphs. This approach enables explicit modeling of hierarchical relationships and long-range dependencies through message passing between nodes. Graph-based architectures can capture complex dependencies that may be difficult to model with purely sequential approaches, though these architectures may require careful design of graph structure and update rules.

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In one or more embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In one or more embodiments, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to a request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In one or more embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, that are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In one or more embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In one or more embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In one or more embodiments, a tenant is associated with a tenant ID. An network resource of the multi-tenant computer network is tagged with a tenant ID. A tenant is permitted access to a particular network resource if the tenant and the particular network resources are associated with a same tenant ID.

In one or more embodiments, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset if the tenant and the particular application, data structure, and/or dataset are associated with a same tenant ID.

As an example, a database implemented by a multi-tenant computer network may be tagged with a tenant ID. Only a tenant associated with the corresponding tenant ID may access data of a particular database. As another example, a entry in a database implemented by a multi-tenant computer network may be tagged with a tenant ID. Only a tenant associated with the corresponding tenant ID may access data of a particular entry. However, the database may be shared by multiple tenants.

In one or more embodiments, a subscription list indicates that tenants have authorization to access that applications. For an application, a list of tenant IDs of tenants authorized to access the application is stored. A tenant is permitted access to a particular application if the tenant ID of the tenant is included in the subscription list corresponding to the particular application.

In one or more embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

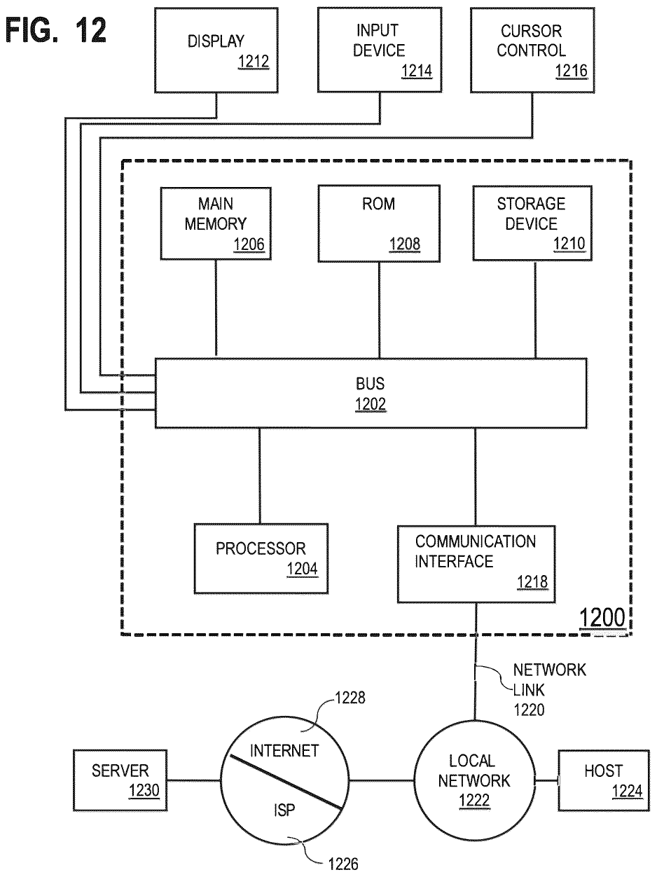

FIG. 12 is a block diagram that illustrates an example computer system 1200 upon which one or more embodiments are implemented. Computer system 1200 includes a bus 1202 or other communication mechanism for communicating information, and a hardware processor 1204 coupled with bus 1202 for processing information. Hardware processor 1204 may be, for example, a general-purpose microprocessor.

Computer system 1200 also includes a main memory 1206, such as a random-access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk, optical disk, or a Solid-State Drive (SSD) is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic that in combination with the computer system causes or programs computer system 1200 to be a special-purpose machine. According to one embodiment, the techniques herein are performed by computer system 1200 based on processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from that processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the worldwide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, that carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner that might adversely affect their validity as trademarks.

Embodiments are directed to a system with one or more devices that include a hardware processor and that are configured to perform any of the operations described herein and/or recited in any of the claims below.

In one or more embodiments, one or more non-transitory computer readable storage media comprises instructions that, when executed by one or more hardware processors, cause performance of any of the operations described herein and/or recited in any of the claims.

In one or more embodiments, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in that such claims issue, including any subsequent correction.

What is claimed is:

1. One or more non-transitory computer-readable media comprising instructions which, when executed, cause one or more computer systems to perform a set of operations comprising:
receiving a source document and a query;
obtaining a plurality of language model responses by processing the source document and the query using multiple language models;
processing the plurality of language model responses to identify a first subset of segments, from the plurality of language model responses, that are both: (a) relevant to the query and (b) determined to be valid based on at least a comparison of the first subset of segments with the source document;
determining a second subset of segments based on at least the first subset of segments wherein the determining the second subset of segments based on at least the first subset of segments is based on at least removing one or more duplicate segments from the first subset of segments;
ordering the second subset of segments based on at least analyzing respective positions of segments of the second subset of segments in at least one of the source document and the plurality of language model responses to yield a ordered second subset of segments; and
generating a response based on at least the ordered second subset of segments.

2. The one or more non-transitory computer-readable media of claim 1, the set of operations further comprising:
generating, for segments of the plurality of language model responses, at least one of:
embedding similarity scores based on comparing embeddings of the segments with embeddings of portions of the source document,
content coverage scores based on comparing content elements from the segments with content elements from the source document, or
factual consistency scores based on evaluating claims from the segments against the source document; and
identifying segments as the first subset of segments based on at least one of: the embedding similarity scores, the content coverage scores, or factual consistency scores.

3. The one or more non-transitory computer-readable media of claim 1, the set of operations further comprising:
segmenting the source document, the query, and the plurality of language model responses using different segmentation strategies, wherein:
the plurality of language model responses are segmented based on sentence boundaries, the query is segmented based on identified topics, and
the source document is segmented based on at least one of a document structure and a topical clustering.

4. The method of claim 1, the set of operations further comprising:
determining a first ordering based on positions of segments from the second subset of segments in the plurality of language model responses;
determining a second ordering based on positions of segments from the second subset of segments in the source document;
determining a third ordering based on topics identified in the query; and
combining the first ordering, the second ordering, and the third ordering to generate the ordered second subset of segments.

5. A method comprising:
receiving a source document and a query;
obtaining a plurality of language model responses by processing the source document and the query using multiple language models;
processing the plurality of language model responses to identify a first subset of segments, from the plurality of language model responses, that are both: (a) relevant to the query and (b) determined to be valid based on at least a comparison of the first subset of segments with the source document;
determining a second subset of segments based on at least the first subset of segments;
ordering the second subset of segments based on at least analyzing respective positions of segments of the second subset of segments in at least one of the source document and the plurality of language model responses to yield a ordered second subset of segments; and
generating a response based on at least the ordered second subset of segments.

6. The method of claim 5, wherein the determining the second subset of segments based on at least the first subset of segments is based on at least removing one or more duplicate segments from the first subset of segments.

7. The method of claim 5, wherein the processing the plurality of language model responses to identify the first subset of segments is based on at least:
generating, for segments of the plurality of language model responses, at least one of:
embedding similarity scores based on comparing embeddings of the segments with embeddings of portions of the source document,
content coverage scores based on comparing content elements from the segments with content elements from the source document, or
factual consistency scores based on evaluating claims from the segments against the source document; and
identifying segments as the first subset of segments based on at least one of: the embedding similarity scores, the content coverage scores, or factual consistency scores.

8. The method of claim 5, further comprising:
segmenting the source document, the query, and the plurality of language model responses using different segmentation strategies, wherein:
the plurality of language model responses are segmented based on sentence boundaries,
the query is segmented based on identified topics, and
the source document is segmented based on at least one of a document structure and a topical clustering.

9. The method of claim 5, wherein the ordering the second subset of segments is based on at least:
determining a first ordering based on positions of segments from the second subset of segments in the plurality of language model responses;
determining a second ordering based on positions of segments from the second subset of segments in the source document;
determining a third ordering based on topics identified in the query; and
combining the first ordering, the second ordering, and the third ordering to generate the ordered second subset of segments.

10. The method of claim 5, wherein the processing the plurality of language model responses to identify the first subset of segments is based on at least:
generating an enhanced query based on at least:
identifying related terms based on the query, and
augmenting the query with the identified related terms;
extracting topics from the enhanced query; and
identifying segments as relevant to the query based on the enhanced query and the extracted topics.

11. The method of claim 5, wherein the processing the plurality of language model responses to identify the first subset of segments is based on at least:
extracting claims from segments of the plurality of language model responses;
dividing the source document into semantic chunks;
generating a matrix of consistency scores by evaluating each extracted claim against the semantic chunks of the source document;
determining, for each extracted claim, a maximum consistency score from the matrix of consistency scores; and
identifying segments as the first subset of segments based on maximum consistency scores of their respective extracted claims.

12. The method of claim 5, wherein:
the obtaining the plurality of language model responses is based on at least processing the source document and the query using the multiple language models in parallel; and
the processing the plurality of language model responses is based on at least:
performing parallel comparisons between segments of the plurality of language model responses and the source document to determine validity, and
performing parallel evaluations between the segments of the plurality of language model responses and the query to determine relevance.

13. The method of claim 5, wherein the ordering the second subset of segments comprises:
generating a plurality of ordering signals based on analyzing positions of segments from the second subset of segments in the source document and the plurality of language model responses;
assigning weights to the plurality of ordering signals based on at least one or more characteristics of at least one of the source document, the query, or the plurality of language model responses; and
generating the ordered second subset of segments by combining the plurality of ordering signals according to their assigned weights.

14. The method of claim 5, wherein the processing the plurality of language model responses to identify the first subset of segments comprises:
extracting topics from the query;
generating an additional category for content not aligned with the extracted topics;
categorizing segments of the plurality of language model responses according to the extracted topics and the additional category; and
identifying segments as relevant to the query based on their categorization and alignment with the extracted topics.

15. A system comprising:
one or more computer systems having one or more hardware processors; and
instructions which, when executed, cause the one or more computer systems to perform a set of operations comprising:
receiving a source document and a query;
obtaining a plurality of language model responses by processing the source document and the query using multiple language models;
processing the plurality of language model responses to identify a first subset of segments, from the plurality of language model responses, that are both: (a) relevant to the query and (b) determined to be valid based on at least a comparison of the first subset of segments with the source document;
determining a second subset of segments based on at least the first subset of segments wherein the determining the second subset of segments based on at least the first subset of segments is based on at least removing one or more duplicate segments from the first subset of segments;
ordering the second subset of segments based on at least analyzing respective positions of segments of the second subset of segments in at least one of the source document and the plurality of language model responses to yield a ordered second subset of segments; and
generating a response based on at least the ordered second subset of segments.

16. The system of claim 15, the set of operations further comprising:
generating, for segments of the plurality of language model responses, at least one of:
embedding similarity scores based on comparing embeddings of the segments with embeddings of portions of the source document,
content coverage scores based on comparing content elements from the segments with content elements from the source document, or
factual consistency scores based on evaluating claims from the segments against the source document; and
identifying segments as the first subset of segments based on at least one of: the embedding similarity scores, the content coverage scores, or factual consistency scores.

17. The system of claim 15, the set of operations further comprising:
segmenting the source document, the query, and the plurality of language model responses using different segmentation strategies, wherein:
the plurality of language model responses are segmented based on sentence boundaries,
the query is segmented based on identified topics, and
the source document is segmented based on at least one of a document structure and a topical clustering.

18. The system of claim 15, the set of operations further comprising:
determining a first ordering based on positions of segments from the second subset of segments in the plurality of language model responses;
determining a second ordering based on positions of segments from the second subset of segments in the source document;
determining a third ordering based on topics identified in the query; and
combining the first ordering, the second ordering, and the third ordering to generate the ordered second subset of segments.

19. The system of claim 15, the set of operations further comprising:
generating an enhanced query based on at least:
identifying related terms based on the query, and
augmenting the query with the identified related terms;
extracting topics from the enhanced query; and
identifying segments as relevant to the query based on the enhanced query and the extracted topics.

20. The system of claim 15, the set of operations further comprising:
extracting claims from segments of the plurality of language model responses;
dividing the source document into semantic chunks;
generating a matrix of consistency scores by evaluating each extracted claim against the semantic chunks of the source document;
determining, for each extracted claim, a maximum consistency score from the matrix of consistency scores; and
identifying segments as the first subset of segments based on maximum consistency scores of their respective extracted claims.
